(19) United States
(12) Patent Application Publication
(10) Pub. No.: US 2026/0015484 A1
(43) Pub. Date: Jan. 15, 2026

(54) CARBONACEOUS MATERIAL HAVING TUNED PHYSICAL AND CHEMICAL PROPERTIES AND METHODS OF MAKING AND USING THE SAME

(71) Applicant: Origin Materials Operating, Inc., West Sacramento, CA (US)

(72) Inventors: Ruairi O'KANE, West Sacramento, CA (US); Yu Gao, West Sacramento, CA (US); Himanshu Patel, West Sacramento, CA (US); Paul Dornath, West Sacramento, CA (US); William R. Williams, West Sacramento, CA (US); Makoto N. Masuno, West Sacramento, CA (US); Ryan L. Smith, Smith Sacramento, CA (US)

(21) Appl. No.: 19/338,579

(22) Filed: Sep. 24, 2025

Related U.S. Application Data
(63) Continuation of application No. PCT/US24/22069, filed on Mar. 28, 2024.
(60) Provisional application No. 63/455,522, filed on Mar. 29, 2023.
(60) Provisional application No. 63/525,306, filed on Jul. 6, 2023.

(51) Int. Cl. C08K 3/04; B60C 1/00; C08J 3/20; C09C 1/56

(52) U.S. Cl. CPC C08K 3/04; B60C 1/00; C08J 3/203; C09C 1/56; C01P 2002/82; C01P 2002/86; C01P 2004/03; C01P 2006/12; C01P 2006/19; C01P 2006/80; C08J 2309/06; C08K 2201/006

(57) ABSTRACT

Disclosed herein is a carbonaceous material exhibiting properties and characteristics that lend to its use in forming composite materials. In particular aspects, the carbonaceous material comprises a carbon content of greater than or equal to 85 wt. %, a surface area ranging from 150 m²/g to 500 m²/g, and an oil absorption value ranging from 50 g/100 g to 100 g/100 g. Also disclosed are methods for making and using the carbonaceous material, including forming composite polymer compositions.

### CROSS REFERENCE TO RELATED APPLICATIONS

This application is a continuation of International Application No. PCT/US2024/22069, filed Mar. 28, 2024, which claims the benefit of, and priority to, U.S. Provisional Application No. 63/455,522, filed Mar. 29, 2023, and U.S. Provisional Application No. 63/525,306, filed on Jul. 6, 2023; all of which are incorporated herein by reference in their entirety.

### FIELD

The present disclosure concerns a carbonaceous material, a composite polymer composition comprising a carbonaceous material, a rubber-containing product comprising a carbonaceous material, a composition comprising a carbonaceous material, and a method of producing a carbonaceous material.

### BACKGROUND

Carbon black can be produced through thermal decomposition (e.g., incomplete combustion) of hydrocarbons, typically from fuel/synthetic feedstocks. Carbon black is a versatile material. Carbon black particles have a complex structure, which can form aggregates and agglomerates; however, such particles can have small diameters (e.g., in the nanometer range), which enables carbon black to absorb and scatter light, giving rise to its namesake “black” color. The color and intensity of carbon black enable it to produce deep shades of dark black when used as a pigment in inks, paints, and other matrices.

Carbon black can also serve as a reinforcing filler in polymer products, such as rubber tires, belts, and hoses. The aspect ratio and particle structure of carbon black results in the formation of a reinforcing network of particles within the polymer matrix. This results in a more durable material, and can also increase the stiffness, dimensional stability, and load-bearing capacity of the polymer matrix.

Conventional carbon black (including the methods used to make it) is associated with environmental and health considerations. In some instances, carbon black is produced by incomplete combustion of fossil fuels, such as petroleum products, coal tar, or natural gas. This can contribute to greenhouse gas emissions and resource consumption. Fossil-based carbon black can also include polycyclic aromatic hydrocarbons (PAHs), which are known carcinogens. Thus, there is need for improved methods of making and using materials that avoid such drawbacks.

### SUMMARY

Disclosed aspects of the present disclosure advantageously provide carbonaceous materials produced from a biomass feedstock. In some aspects of the present disclosure, a carbonaceous material produced from a biomass feedstock comprises a carbon content of greater than or equal to 85 wt. %. In some aspects, the carbonaceous material further comprises a surface area ranging from 150 m²/g to 500 m²/g and/or an oil absorption value ranging from 50 g/100 g to 100 g/100 g.

Certain disclosed aspects concern a method of producing the carbonaceous material of the present disclosure. In some aspects, the method comprises obtaining a parent carbonaceous material from a biomass feedstock and post-treating the parent carbonaceous material, which may comprise a portion of unreacted biomass feedstock, a macromolecular furan derivative, a cellulose compound, a lignin-based compound, or a combination thereof. In some aspects, the parent carbonaceous material is post-treated to at least partially deoxygenate the parent carbonaceous material to provide the carbonaceous material according to the present disclosure. In an independent aspect, post-treating the parent carbonaceous material does not comprise treating the parent carbonaceous material with an activating agent.

The foregoing and other objects, features, and advantages of the present disclosure will become more apparent from the following detailed description, which proceeds with reference to the accompanying figures.

### BRIEF DESCRIPTION OF THE DRAWINGS

FIGS. 1A-1F are SEM micrographs of a parent carbonaceous material produced from 100% southern pine feedstock.

FIGS. 2A-21 are SEM micrographs of examples of parent carbonaceous materials and carbonaceous materials according to aspects of the present disclosure (FIGS. 2A-2G) and comparison materials (FIGS. 2H and 2I), wherein FIGS. 2A and 2C show SEM micrographs of parent carbonaceous materials produced from a lignin-free feedstock comprising 100% cornstarch (FIG. 2A) and a lignin-containing feedstock comprising 100% southern pine wood (FIG. 2C); FIGS. 2B and 2D-2G show SEM micrographs of the carbonaceous materials obtained from particular parent materials; and FIGS. 2H and 2I show images of a comparison material that lacks the structural features exhibited by materials of the present disclosure.

FIG. 3 schematically illustrates several different properties of carbon black, including surface functionality, porosity and surface area, primary particle size, aggregate particle size, and aggregate structure.

FIG. 4 is a schematic drawing illustrating one disclosed example comprising a system for converting a biomass feedstock into a parent carbonaceous material that can be converted to a carbonaceous material of the present disclosure.

FIG. 5 is a schematic drawing illustrating one disclosed example comprising a system for converting a biomass feedstock into a parent carbonaceous material comprising lignin and/or humins.

FIG. 6 shows 1-D CP MAS solid-state ¹³C NMR spectra of examples of carbonaceous material obtained from a post-treated parent carbonaceous material, particularly a parent material that has been heat-treated at different temperatures.

FIG. 7 shows Raman spectra (obtained using a 785 nm wavelength laser) of the carbonaceous material of FIG. 6 that was obtained from the post-treatment (e.g., heat-treatment under an inert gas at different temperatures).

FIGS. 8A-8C shows Raman BET, STSA, and micropore surface area of examples of the carbonaceous material disclosed herein as a function of temperature.

FIG. 9 shows nitrogen physisorption isotherms of examples of the carbonaceous material disclosed herein, wherein closed circles represent adsorption and open circles represent desorption, as compared to the parent carbonaceous material and a commercially available carbon black, N660.

FIGS. 10A and 10B show pore size distributions (FIG. 10A) and cumulative pore volume (QSDFT, slit pore model, adsorption branch; FIG. 10B) obtained from the nitrogen physisorption data of FIG. 9.

FIG. 11 shows a 1-D quantitative direct polarization (DP) MAS solid-state ¹³C NMR spectrum with on a parent carbonaceous material generated from a lignin-free feedstock comprising ¹³C-enriched glucose and is annotated with a proposed molecular structure of a humin present in the parent carbonaceous material derived from the lignin-free feedstock.

FIG. 12 shows the NMR spectrum of FIG. 11 overlaid with a 1-D quantitative DP MAS solid-state ¹³C NMR spectrum of a parent carbonaceous material generated from a lignin-containing feedstock comprising ¹³C-enriched lignocellulosic biomass, wherein the spectral intensity was normalized such that each spectrum has a similar overall integral for ease of comparison; the NMR spectra are annotated with chemical moieties corresponding to structures present in the parent carbonaceous materials.

FIG. 13 shows the aromatic region of a 2-D ¹³C-¹³C CP INADEQUATE solid-state NMR spectrum of the parent carbonaceous material generated from the lignin-free feedstock of FIG. 11 and which illustrates the NMR signature of humin in the aromatic region of the 2D NMR spectrum (e.g., between 100-165 ppm SQ ¹³C chemical shift and 210-310 ppm DQ ¹³C chemical shift).

FIG. 14 shows the aromatic region of a 2-D ¹³C-¹³C CP INADEQUATE solid-state NMR spectrum of the parent carbonaceous material generated from the lignin-containing feedstock of FIG. 12 and which illustrates signature NMR relationships corresponding to lignin.

FIG. 15 shows examples of MDR rheology of SBR cure packages with varying levels of TBBS accelerator, wherein the cure package further comprises a carbonaceous material derived from a parent carbonaceous material produced from 100% southern pine and then heat treated for 2 hours at 850° C. followed by dry media milling).

FIG. 16 shows tensile stress/strain for two examples of a carbonaceous material obtained from a parent carbonaceous material that was heat-treated and dry media milled for different durations.

FIGS. 17A-17B are SEM micrographs of additional examples of carbonaceous material, wherein FIG. 17A shows a SEM micrograph of a carbonaceous material that was obtained from a heat-treated parent carbonaceous material that was dry-media-milled for four minutes and FIG. 17B shows a SEM micrograph of a heat-treated parent carbonaceous material that was dry-media-milled for 40 minutes.

FIG. 18 shows dynamic modulus data of carbonaceous material obtained from a heat-treated parent carbonaceous material subjected to media milling as compared with a gum rubber sample and an N660 sample.

FIG. 19 shows tensile stress/strain data for examples based on a carbonaceous material obtained from a parent carbonaceous material that was jet-milled using different classifier rotation speeds and wherein samples derived from (i) N660 carbon black and (ii) a carbonaceous material obtained from a parent carbonaceous material exposed to a 40-minute media milling are also shown for comparison.

FIG. 20 shows tensile stress/strain data for examples based on a carbonaceous material obtained from a jet-milled parent carbonaceous material under different conditions and extracted from a cyclone or baghouse collector of the jet-milling apparatus, wherein samples derived from (i) N660 carbon black and (ii) a carbonaceous material obtained from a parent carbonaceous material exposed to a 40-minute media milling are also shown for comparison.

FIG. 21 shows tensile stress/strain data for carbonaceous material examples based on baghouse carbonaceous material blended with N660 carbon black at 5%, 10%, 20%, 30%, and 40% loading ratios, wherein an average of data derived from N660 carbon black is shown for comparison.

FIG. 22 shows tensile stress/strain data for additional examples based on cyclone carbonaceous material derived from a parent carbonaceous material obtained from a blend of CS/HW, wherein the carbonaceous material was blended with N660 carbon black at 5%, 10%, and 20% loading ratios; an average of data derived from N660 carbon black is shown for comparison.

FIG. 23 shows a comparison of tensile stress/strain data for examples of polymer materials comprising different types of filler materials: (i) N660 carbon black, (ii) carbonaceous material obtained from post-treating a parent carbonaceous material obtained from 100% wood feedstock (denoted as “100% SP”), (iii) carbonaceous material obtained from post-treating a parent carbonaceous material obtained from a CS/wood blend (denoted as “65/35 CS/HW”), and (iv) carbonaceous material obtained from post-treating a parent carbonaceous material obtained from 100% corn starch (denoted as 100% CS).

FIG. 24 shows a comparison of tensile stress/strain data for examples of polymer materials comprising different types of filler materials: (i) N660 carbon black, (ii) N990 carbon black, and (ii) carbonaceous material obtained from post-treating a parent carbonaceous material obtained from corn starch, wherein the carbonaceous material is included at amounts of 5%, 10%, 20%, and 100%.

FIG. 25 is a graph of tan delta as measured for various blends of N660 with different levels of jet-milled carbonaceous material.

FIG. 26 is a graph of tension storage modulus as measured for various blends of N660 with different levels of jet-milled carbonaceous material.

FIG. 27 is a graph of tension loss modulus for various blends of N660 with different levels of jet-milled carbonaceous material.

### DETAILED DESCRIPTION

### I. Abbreviations

1D: one-dimensional.
2D: two-dimensional.
AFEX: ammonia fiber explosion.
atm: 1 atmosphere pressure.
avg: average.
barg: gauge pressure (in bars).
BH: baghouse.
BR: bound rubber.
C6: a molecule comprising six carbon atoms.
CP-INADEQUATE: cross-polarization Incredible Natural Abundance Double Quantum Transfer Experiment.
CS: corn starch.
CY: cyclone.
D50 value: in a particle size distribution, the D50 value represents the particle size at which 50% of the cumulative mass of particles is smaller and 50% is larger.
D90 value: in a particle size distribution, the D90 value represents the particle size at which 90% of the cumulative mass of particles is smaller and 10% is larger.
DOE: design of experiment.
DP: direct polarization.
HW: hardwood.
MAS: magic angle spinning.
nm: nanometer.
OAN: oil absorption number (also referred to as “oil absorption value”).
OCC: old corrugated containers/cardboard.
ONP: old newspaper.
P: reaction pressure.
Pa: Pascal pressure.
PAH: polycyclic aromatic hydrocarbon.
ppm: parts per million.
psi: pound-force per square inch.
SA: surface area.
SBR: styrene-butadiene rubber.
SEM: scanning electron microscopy.
SP: southern pine.
ssNMR: solid state nuclear magnetic resonance.
TBBS: N-tert-butyl-benzothiazole sulfonamide.
UV: ultraviolet.
wt. %: weight percent.

### II. Overview of Terms, Ranges, and Definitions

Both the foregoing general description and the following detailed description are exemplary and explanatory only and are not intended to limit the scope of the present disclosure.

As used herein, the use of the singular includes the plural unless specifically stated otherwise. For example, the singular forms “a”, “an” and “the” as used in the specification also include plural aspects unless the context dictates otherwise. Similarly, any singular term used in the specification also means plural or vice versa, unless the context dictates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

The disclosure of numerical ranges should be understood as referring to each discrete point within the range, inclusive of endpoints, unless otherwise noted. Unless otherwise indicated, all numbers expressing quantities of ingredients, properties such as molecular weight, percentages, and so forth, as used in the specification or claims are to be understood as being modified by the term “about.” Accordingly, unless otherwise implicitly or explicitly indicated, or unless the context if properly understood by a person of ordinary skill in the art (with the benefit of the present disclosure) to have a more definitive construction, non-numerical properties such as amorphous, continuous, crystalline, homogeneous, and so forth as used in the specification or claims are to be understood as being modified by the term “substantially,” meaning to a great extent or degree. Accordingly, unless otherwise indicated, implicitly or explicitly, the numerical parameters and/or non-numerical properties set forth are approximations that may depend on the desired properties sought, limits of detection under standard test conditions/methods, limitations of the processing method, and/or the nature of the parameter or property. When directly and explicitly distinguishing example from discussed prior art, the disclosed numbers are not approximates unless the word “about” is recited.

The term “or combinations thereof” as used herein refers to all permutations and combinations of the listed items preceding the term. For example, “A, B, C, or combinations thereof” is intended to include at least: A, B, C, AB, AC, BC, or ABC, and if order is important in a particular context, also BA, CA, CB, ACB, CBA, BCA, BAC, or CAB. Continuing with this example, expressly included are combinations that contain repeats of one or more item or term, such as BB, AAA, AAB, BBC, AAABCCCC, CBBAAA, CABABB, and so forth.

The term “activating agent” refers to a reactive chemical agent used to form an impregnated material, such as an impregnated carbon material with a high surface area (e.g., a surface area in excess of 500 m²/g), to form a chemically reactive product. In aspects of the present disclosure, an activating agent is a chemical that is affirmatively added to a parent carbonaceous material to impregnate the material to form activated carbon therefrom. Activating agents can include a base, an acid, a metal halide, a urea, or a combination thereof, that is affirmatively added to facilitate impregnation of a parent carbonaceous material. Aspects of the products and methods disclosed herein do not comprise using an activating agent. Any acid, base, metal halide, and/or urea that might be disclosed for use in preparing a parent carbonaceous material according to the present disclosure is not an activating agent and is not added to facilitate impregnation to thereby form activated carbon.

The term “biomass feedstock” generally refers to any plant or plant-derived material made up of organic compounds relatively high in oxygen, such as carbohydrates, which can be used as a starting material to produce the carbonaceous material disclosed herein. In some aspects of the present disclosure, the biomass feedstock comprises lignin-free material as described in more detail below. In some more specific aspects, the biomass feedstock comprises plant-based lignin-free material. In other aspects of the present disclosure, the biomass feedstock comprises a lignin-containing material as described in more detail below.

The term “carbonaceous material” generally refers to a material that comprises carbon and that has been obtained from a parent carbonaceous material via a post-treatment and has a lower oxygen content than the parent carbonaceous material. In some examples, the carbon is a majority component (e.g., carbon is greater than 80 wt. % of the carbonaceous material). In some aspects of the present disclosure, the carbonaceous material comprises a carbon content of greater than or equal to 85 wt. %, a surface area ranging from 150 m²/g to 500 m²/g, and an oil absorption value ranging from 50 g/100 g to 100 g/100 g.

The term “carbon black” generally refers to carbon material produced by incomplete combustion of coal tar or petroleum products and does not include the carbonaceous material according to the present disclosure.

The term “carbon content” generally refers to an amount of carbon in a substance. In the examples disclosed herein, the carbon content may be determined by elemental analysis according to DIN 51732.

The term “cellulose” generally refers to a naturally occurring polysaccharide of about 70 to more than 10,000 β(1→4) linked D-glucose units in a linear chain. Cellulose has the general formula (C₆H₁₀O₅)ₙ:

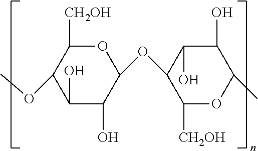

Cellulose is a structural component of plant cell walls. About one third of plant matter is cellulose. Wood contains approximately 50% cellulose by weight. Cellulose polymers can be characterized by the degree of polymerization, which is the number of monomer units, i.e., glucose units. Cellulose polymers may contain from several hundred to several thousand glucose units. For example, the degree of polymerization can range from about 1000 for wood pulp to about 3500 for cotton fiber. Cellulose can be decomposed into glucose by hydrolysis or by the enzyme cellulase.

The term “composite polymer composition” generally refers to a solid material composed of two or more constituent materials having different physical and/or chemical characteristics that, when combined, produce a material in which each substance retains its identity while contributing desirable properties to the whole. By “retains its identity” is meant that the individual materials remain separate and distinct within the composite structure. A composite is not a solid solution or a simple physical mixture of the constituent materials. In other words, each particle of the composite includes regions or domains of the two or more constituent materials.

The term “curing” generally refers to a chemical process resulting in the formation of polymer chains. The curing process can include linking monomer units, dimer units, oligomer units, or a combination thereof, together. The curing process can additionally or alternatively include cross-linking between polymer chains or portions of polymer chains.

The term “deoxygenate” generally refers to a chemical process that results in removal of oxygen atoms or molecules from a composition of matter.

The term “derivative” generally refers to a compound that is derived from a similar compound or a compound that can be imagined to arise from another compound, for example, if one atom is replaced with another atom or group of atoms.

The term “dispersion” generally refers to a system in which particles are dispersed within a continuous phase of a different composition. A solid dispersion is a system in which at least one solid component is dispersed in another solid component. A molecular dispersion is a system in which at least one component is homogeneously or substantially homogeneously dispersed on a molecular level throughout another component.

The term “elastomer” generally refers to a polymer material that is capable of recovering its original shape after being stretched. Examples of elastomers include, but are not limited to, natural rubber (e.g., gum rubber), synthetic rubber (such as neoprene, isoprene rubber, silicone rubber, and butyl rubber), and thermoplastic elastomers (TPEs).

The term “filler material” generally refers to a substance that is added to a polymer to modify its properties. In some aspects of the present disclosure, the filler material comprises particulate material dispersed within a continuous phase of a different composition. In some more specific aspects of the present disclosure, the filler material comprises carbonaceous material, carbon black, or a combination thereof.

The term “furan” generally refers to heterocyclic organic compound comprising a five-membered aromatic ring with four carbon atoms and one oxygen atom.

The term “hardening” generally refers to formation of a solid material by cooling the material. An example of hardening is solidifying a thermoplastic polymer by cooling the thermoplastic polymer below its melting point or glass transition temperature.

The term “heat-treating” generally refers to exposing a material to a temperature above its ambient temperature to alter the physical and/or chemical properties of the material. In some aspects of the present disclosure, heat-treating includes heating a carbonaceous material at 300° C. or greater, such as 300° C. to 1000° C. or higher.

The term “humin” generally refers to a polymeric material that is insoluble in water and comprises high molecular weight furan derivatives. Humins are typically dark-colored solids formed through a series of complex chemical reactions, such as ring-opening, dehydration, and condensation, and can be produced by the decomposition of carbohydrates and other organic compounds present in biomass.

The term “lignin” generally refers to a complex organic polymer that is a major component of the cell walls of plants. Lignin provides structural support to plants and helps conduct water from the roots to the leaves. Lignin comprises a heterogeneous and irregular polymer network of aromatic alcohols known as monolignols, such as coniferyl alcohol, sinapyl alcohol, and p-coumaryl alcohol.

The term “lignin-containing material” generally refers to a material that includes lignin. Examples of lignin-containing materials include wood, grass, and paper products.

The term “lignin-free material” generally refers to a material that is substantially free of lignin. Examples of lignin-free materials include plant-derived carbohydrates, such as glucose and cellulose.

The term “macromolecular” generally refers to a polymeric molecule that has a relatively large molecular weight or structure relative to its monomer units.

The term “matrix” generally refers to a polymeric material in which a filler material is mixed or dispersed.

The term “milling” generally refers to a physical process in which a solid material is reduced in size. Milling can involve grinding, crushing, or cutting the solid material to produce smaller pieces or particles. Examples of milling processes include jet milling, ball milling, media milling, grinding, classifier milling, or a combination thereof.

The term “moiety” generally refers to a fragment of a molecule, or a portion of a conjugate.

The term “oil absorption value” generally refers to a measure of a material's ability to absorb oils or other non-polar liquids. The oil absorption value can be determined in accordance with ASTM D2414-15 “Standard Test Method for Carbon Black-Oil Absorption Number (OAN).”

The term “parent carbonaceous material” generally refers to a carbonaceous material as-produced from a process wherein a biomass feedstock is exposed to an acid, but before any post-treating step according to a method descried herein.

The term “particulate material” generally refers to a material comprising one or more discrete masses. The term “particle” is commonly understood to mean a very small or tiny mass of a material.

The term “polycyclic aromatic hydrocarbons” or “PAHs” generally refers to a hydrocarbon molecule comprising a plurality of aromatic rings.

The term “polymer” generally refers to a molecule of repeating structural units (e.g., monomers) formed via a chemical reaction, i.e., polymerization.

The term “post-treating” generally refers to performing a chemical or physical process on a parent carbonaceous material after it has been manufactured to provide a carbonaceous material according to aspects of the present disclosure. In an independent aspect, post-treating does not include exposing a parent carbonaceous product to an activating agent.

The term “pre-polymer material” generally refers to a chemical composition and/or a chemical compound that contains reactive functional groups capable of polymerization. Examples of a pre-polymer material include partially polymerized resins containing reactive functional groups, such as epoxy, polyester, isocyanate, or polyurethane. Other examples of pre-polymer materials include partially polymerized silicone compounds with reactive functional groups, such as vinyl-terminated or hydride-terminated siloxane chains. Yet other examples of pre-polymer materials include polyamide prepolymers, also known as nylon prepolymers, which can contain amine and carboxylic acid functional groups. Pre-polymer materials serve as starting points for further polymerization reactions, often with the addition of crosslinkers, catalysts, or other additives, to form polymer products with desired properties.

The term “primary particles” generally refers to the smallest units of a material from which larger aggregates or agglomerates are formed. In some aspects, primary particles are non-discrete and are fused at the necks of the particles.

The term “rubber” generally refers to a type of elastomeric material. In some examples, rubber occurs naturally, e.g., in the form of latex. Rubber can additionally or alternatively be synthesized through the polymerization of various monomers, such as styrene, butadiene, and isoprene.

The term “rubber-containing product” generally refers to a device/apparatus or a composition of matter comprising rubber. Some examples of rubber-containing products include automobile tires, industrial belts and hoses, seals, and gaskets.

The term “tensile strength” generally refers to a measure of the maximum amount of tensile (pulling) stress that a material can withstand before breaking or fracturing. It represents the resistance of a material to being pulled apart or stretched under tension. Tensile strength is typically expressed in units of force per unit area, such as pounds per square inch (psi).

The term “thermoplastic polymer” generally refers to a material that is capable of being heated and softened multiple times. Examples of thermoplastic polymers include polyethylene, polypropylene, polyvinyl chloride, polystyrene, polyethylene terephthalate, and polycarbonate. In some aspects of the present disclosure, the thermoplastic polymer comprises a thermoplastic elastomer. Examples of thermoplastic elastomers include styrenic block copolymers (e.g., styrene-butadiene-styrene and styrene-ethylene-butylene-styrene), thermoplastic polyurethanes, thermoplastic olefins (e.g., ethylene propylene diene monomer rubber, polyethylene, and polypropylene), thermoplastic vulcanized rubber.

The term “turbostratic carbon” generally refers to a material in which carbon atoms are arranged in layers. In turbostratic carbon, the layers of the carbon atoms are not aligned with each other. The carbon layers can be randomly oriented, or otherwise lack long-range order. This disordered structure gives rise to different properties than more ordered structures, like in graphite.

### III. Introduction

As introduced above, carbon black materials are versatile; however, the production of carbon black is associated with environmental and health considerations. To address these issues and other drawbacks associated with conventional carbon black materials, the present disclosure provides carbonaceous materials produced from a biomass feedstock that can be used to replace conventional carbon black materials. In some aspects of the present disclosure, the carbonaceous material comprises a carbon content of greater than or equal to 85 wt. %. In yet additional aspects, the carbonaceous material has a surface area ranging from 150 m²/g to 500 m²/g. In yet additional aspects, the carbonaceous material exhibits an oil absorption value ranging from 50 g/100 g to 100 g/100 g. Additional features of the carbonaceous materials of the present disclosure are described herein. Advantageously, production of the carbonaceous material disclosed herein results in fewer carbon emissions than conventional fossil-based carbon black. In an independent aspect, the carbonaceous material has no detectable levels of PAHs or levels of PAH that are below a detectable limit, reducing the negative health impact associated with conventional carbon black materials.

### IV. Carbonaceous Material

The chemical structure of parent carbonaceous materials used to make the carbonaceous materials according to the present disclosure, is highly functionalized and relatively hydrophilic compared to the carbonaceous material. Some composite polymer materials require hydrophobic fillers and/or fillers that have relatively fewer oxygen-containing groups than the parent carbonaceous material. Accordingly, the parent carbonaceous material can be post-treated to at least partially deoxygenate the parent carbonaceous material to form the carbonaceous material according to the present disclosure. Without being limited to a single theory, it currently is believed that the post-treatment facilitates forming a more hydrophobic turbostratic-like surface.

In some aspects, the chemical structure of the carbonaceous material can include a portion of unreacted biomass feedstock, a macromolecular furan derivative, a cellulose compound, a lignin-based compound, or any combination thereof. Examples of macromolecular furan derivatives include humins. Humins are macromolecules with a polymeric, furanic-type structure. Without wishing to be bound by any theory, in one possible mechanism, humins can form as a result of ring-opening hydrolysis and cross-linking and/or branching of furans. As described in more detail below, humins can be insoluble and remain in the solid phase along with unreacted biomass during the production of the carbonaceous material. In some aspects, the carbonaceous material derived from lignin-containing biomass is dominated by lignin-based moieties, indicating the presence of unreacted lignin, partially decomposed lignin, lignin derivatives, or a combination thereof.

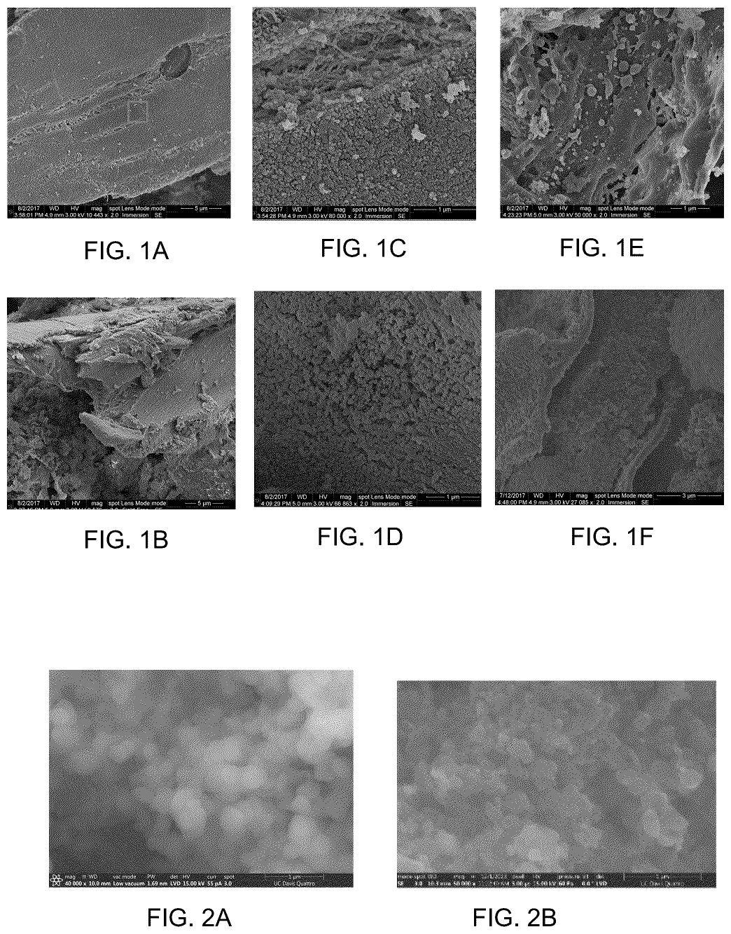

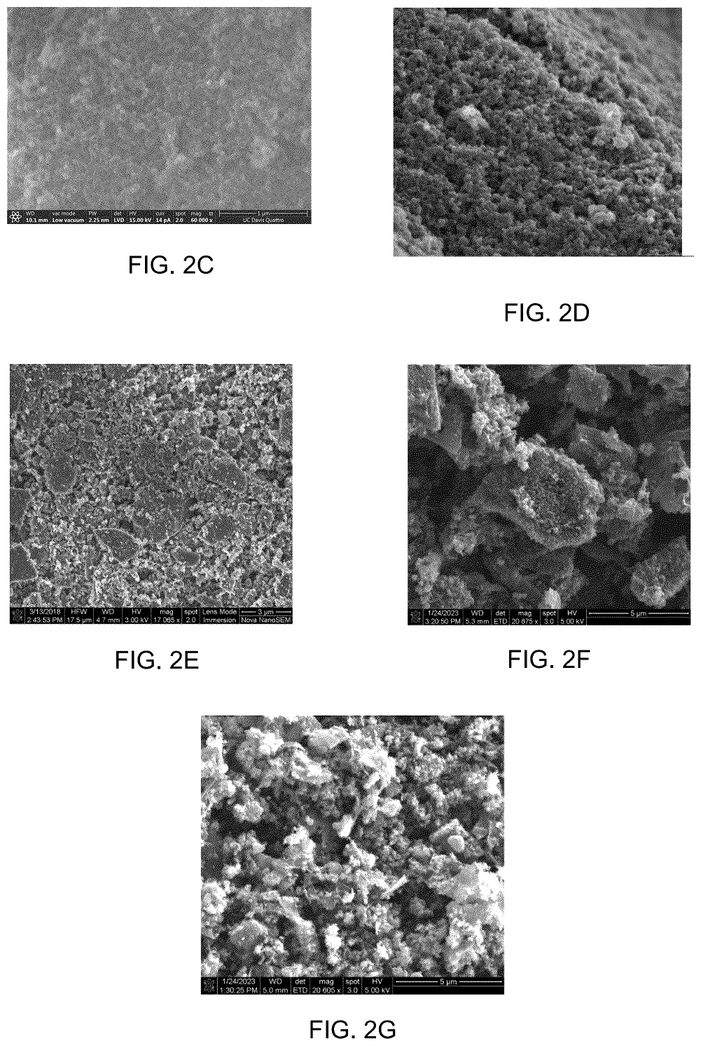

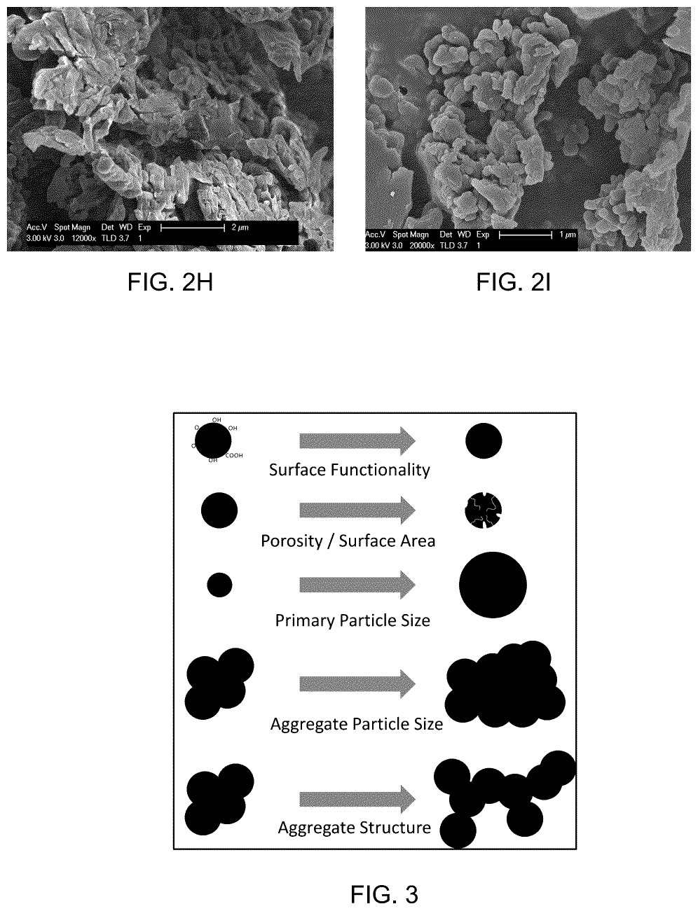

In some aspects of the present disclosure, the carbonaceous material is in the form of a particulate material. Particles of a parent carbonaceous material (before post-treatment) can have texture/features of a wide variety of length-scales. For example, a parent carbonaceous material derived from wood can have some particles that are 0.1 to 10 mm in size and are roughly shaped like particles of wood feedstock, as shown in FIGS. 1A and 1B. However, the parent carbonaceous material also contains primary particles having an average particle size in the range of 30 nm to 100 nm (or 3×10⁻⁵ mm to 1×10⁻⁴ mm). FIGS. 1C and 1D show magnified views of the parent carbonaceous material of FIGS. 1A and 1B, respectively, revealing the primary particles in greater detail. FIGS. 1E and 1F show additional views of the parent carbonaceous material of FIGS. 1A and 1B, respectively, showing the layered, hierarchical nature of the parent carbonaceous material's structure. This hierarchical structure can be retained in the carbonaceous material obtained from the parent material. Materials obtained using certain methods known in the art do not form such hierarchical structures. For example, exposing a biomass feedstock according to the present disclosure, such as corn starch, to processing conditions of a method known in the art including concentrated HCl produces a material that lacks discrete particles and any hierarchical structure, as can be seen in FIGS. 2H and 2I.

In some aspects, the primary particles present in the parent carbonaceous material used to make the carbonaceous material can have a D50 value of 100 nm or larger, but typically smaller than 1 micron. In some such aspects, the primary particles present in the parent carbonaceous material have a D50 value of 200 nm or larger, but typically smaller than 1 micron. FIG. 2A shows an example of a parent carbonaceous material derived from a feedstock comprising cornstarch. The parent carbonaceous material of FIG. 2A has a primary particle D50 of 236 nm. FIG. 2B shows an example of a carbonaceous material obtained from the parent material of FIG. 2A, which was obtained from heat-treating the parent material and then media-milling.

In contrast, the primary particles present in carbonaceous materials obtained from lignin-containing feedstocks can be smaller than the carbonaceous materials obtained from lignin-free feedstocks. FIG. 2C shows a parent carbonaceous material derived from a feedstock comprising southern pine. FIG. 2D shows a carbonaceous material obtained from the parent material of FIG. 2C prior to media-milling and FIG. 2E shows the carbonaceous material after media-milling. The parent carbonaceous material of FIG. 2C has a primary particle D50 of 45 nm. Some products formed from lignin-containing feedstocks can comprise primary particles having diameters in the range of 10 nm to 100 nm, as illustrated in FIGS. 1A-1F. This difference in primary particle size can also affect the surface area (SA) of the material. In some aspects, the SA is in the range of 10 to 100 m²/g, with lignin-free feedstocks producing material with a lower surface area and lignin-containing feedstocks producing material with higher SA. For example, the parent carbonaceous material of FIG. 2A has a SA of 10 m²/g to 20 m²/g, such as 12-16 m²/g. The carbonaceous material of FIG. 2B has a SA of about 50-90 m²/g.

The ability to tune the morphology of carbonaceous materials according to the present disclosure is advantageous for arriving at materials that can replace or supplement conventional carbon blacks. Several varieties of carbon black exist, which can be broadly classified into three categories by particle size: reinforcing, semi-reinforcing, and non-reinforcing. Reinforcing carbon black generally comprises relatively small particles, with sizes ranging from about 20 to 100 nm. Reinforcing carbon black is characterized by its ability to increase the tensile strength, tear resistance, and abrasion resistance of polymers, such as rubber materials. Non-reinforcing carbon black comprises larger particles, generally above 200 nm. This type of carbon black does not significantly affect the mechanical properties of composite materials but may contribute to other properties, such as conductivity or UV protection. Semi-reinforcing carbon black falls between reinforcing and non-reinforcing types, with particle sizes typically ranging from around 100 to 200 nm. It offers moderate reinforcement properties compared to reinforcing carbon black and non-reinforcing carbon black but can offer a balance between strength and flexibility. By tuning the particle sizes, the carbonaceous material can be used to replace and/or supplement grades of all three types of carbon black.

In some aspects, the carbonaceous material has a surface area ranging from 150 m²/g to 600 m²/g, such as 150 m²/g to 550 m²/g, or 150 m²/g to 500 m²/g, or 150 m²/g to 450 m²/g, or 150 m²/g to 400 m²/g, or 150 m²/g to 350 m²/g. In some aspects, the carbonaceous material has a surface area ranging from 150 m²/g to 330 m²/g. The carbonaceous material has a porosity level that can be achieved by heat treating the parent carbonaceous material. This porosity can increase the surface area (SA) of the carbonaceous material relative to the parent material. For example, the SA of SP-derived parent carbonaceous material is in the range of 57-89 m²/g, which increases to 270-295 m²/g in the carbonaceous material after heat-treating the parent material and media milling, and without the application of an activating agent. The SA of this example is 140 m²/g to 200 m²/g without milling. In this particular example, heat-treating occurred at 1000° C. In some other aspects, lower temperatures (e.g., 850° C.) can provide SA values of 380 m²/g to 430 m²/g before any milling and then up to 500 m²/g after milling (e.g., media milling). The SA of CS-derived parent carbonaceous material is in the range of 12-16 m²/g, which increases to 315 m²/g in the carbonaceous material after heat-treating the parent material and media milling. A value of 259 m²/g was obtained for this example prior to milling. The SA of CS/HW-derived parent carbonaceous material is in the range of 45-64 m²/g, which increases to 170-185 m²/g in the carbonaceous material after heat-treating the parent material and milling (e.g., jet-milling). FIGS. 2F and 2G show images of carbonaceous material obtained from heat-treating and jet-milling a CS/HW-derived parent carbonaceous material, wherein FIG. 2F shows the cyclone portion of the carbonaceous material and FIG. 2G shows the baghouse portion.

In some aspects of the present disclosure, the carbonaceous material has an oil absorption value ranging from 50 g/100 g to 100 g/100 g, such as 50 g/100 g to 99 g/100 g, or 60 g/100 g to 95 g/100 g, or 60 g/100 g to 90 g/100 g, or 60 g/100 g to 85 g/100 g, or 60 g/100 g to 80 g/100 g, or 60 g/100 g to 75 g/100 g. In some specific aspects, the oil absorption value ranges from 57 g/100 g to 75 g/100 g, including 71 g/100 g to 75 g/100 g, 65 g/100 g to 80 g/100 g, and 65 g/100 g to 75 g/100 g. The oil absorption value, or oil absorption number (OAN) measures the amount of oil that can be added to a material and still achieve a percolation network. For example, the oil absorption value of a 100% CS-derived carbonaceous material is 65.4 g/100 g. This is indicative of the carbonaceous material's structure (in this case, structure means how branched the aggregates particles are). For comparison, the OAN of N660 is 91.4 g/100 g, the OAN of 100% SP heat-treated carbonaceous material is in the range of 71.9-74.4 g/100 g, and the OAN of CS/HW parent carbonaceous material is 7.9 g/100 g.

Compared to carbon black, the disclosed carbonaceous material is more carbon negative in its production. Furthermore, the source material used to make the carbonaceous material has a carbon intensity (C.I.) of −1.7 kg CO₂ per kg of carbonaceous material (dry basis), whereas fossil-fuel derived furnace carbon black has an historic average C.I. of +2.4 kg CO₂ per kg of carbon black produced. Fossil-based ASTM grades of carbon black also have high levels of PAHs, which are known carcinogens. PAHs have not been detected in the disclosed carbonaceous materials (i.e., the PAH content is less than the limit of detection, such as 0 mg/kg to less than 0.5 mg/kg, 0 mg/kg to less than 0.4 mg/kg, 0 mg/kg to less than 0.3 mg/kg, or 0 mg/kg to less than 0.2 mg/kg), and are not expected to be present due to the high temperatures of the heat-treatment process. The disclosed carbonaceous materials also exhibit better performance than other bio-based solutions, and perform better in terms of sustainability than incumbent carbon black.

In some aspects of the present disclosure, the carbonaceous material has a carbon content of greater than or equal to 85 wt. %, such as 85 wt. % to 100 wt. %, or 90 wt. % to 100 wt. %, or 95 wt. % to 100 wt. %. In some aspects, the carbonaceous material has a carbon content of greater than 90 wt. %, such as 91 wt. %, or 92 wt. %, or 93 wt. %, or 94 wt. %, or 95 wt. %, or 96 wt. %, or 97 wt. %, or 98 wt. %, or 99 wt. %. In some aspects, these carbon content values can be obtained by heat-treating a parent carbonaceous material as described herein at a temperature of 850° C. or higher (e.g., 850° C. to 1000° C.). For example, in some aspects, a southern pine (SP)-derived carbonaceous material heat-treated at 1000° C. has a carbon content ranging from 93-95%. In another exemplary aspect, a CS/HW-derived carbonaceous material has a carbon content ranging from 91-96%. The carbon content can be used as a proxy value for deoxygenation level and hydrophobicity, which can be tuned by altering the conditions of the heat treatment step.

In some representative aspects, the carbonaceous material is obtained from a parent carbonaceous material that has been heat-treated at a temperature of 850° C. (or higher) and the carbonaceous material has a carbon content of greater than or equal to 85 wt. %; a surface area ranging from 150 m²/g to 500 m²/g; and an oil absorption value ranging from 50 g/100 g to 100 g/100 g. In yet additional representative aspects, the carbonaceous material is obtained from a parent carbonaceous material that has been heat-treated at a temperature of 850° C. (or higher) and the carbonaceous material has a carbon content of greater than or equal to 90 wt. %; a surface area ranging from 150 m²/g to 330 m²/g; and an oil absorption value ranging from 50 g/100 g to 80 g/100 g.

### V. Uses of Carbonaceous Material

Carbonaceous material as disclosed herein can be used as a feed material for a wide array of applications. The suitability for the applications can, in some aspects, depend on properties of the carbonaceous material, such as primary particle size, aggregate particle size, surface area/porosity, surface functionality/hydrophobicity, and/or aggregate structure.

The carbonaceous material can be used as a platform for a variety of carbon products (including a carbon black surrogate and/or supplement). The morphology of the carbonaceous material plays a role in its ability to be used in some products and/or in some functions, such as fillers for composite materials. The morphology of the carbonaceous material can be affected by a number of factors including, but not limited to: feedstock, reaction time, temperature, acid concentration, brine concentration, organic to aqueous phase ratio, reactor geometry, impeller design, impeller stir speed, feedstock loading amounts, and other factors.

The tunable morphology of the carbonaceous material, including tunable primary particle size, enables the carbonaceous material to be engineered to perform analogously to various carbon black grades (e.g., N660 carbon black, N990 carbon black, carcass-grade carbon black, tread-grade carbon black, and others) as well as other specialty blacks that include different degrees of hydrophilicity or oxygen content. Accordingly, the carbonaceous material disclosed herein can be used as a carbon black replacement (for reinforcing and non-reinforcing, and colorant applications) and/or supplement (e.g., it can be used with carbon black). In some independent embodiments, the carbonaceous material can be used as activated carbon and/or a fuel. The hydrophobicity of the carbonaceous material also can be tuned, which may improve compatibility with different solvents.

In particular aspects of the disclosure, the carbonaceous material according to the present disclosure is used as a filler for a composite polymer material, such as a reinforcing filler in an elastomer. The carbonaceous material can exhibit desirable properties that carbon blacks exhibit. Some such properties are shown in FIG. 3, and can include, but are not limited to, surface functionality, porosity, primary particle size, aggregate particle size, and/or aggregate structure.

Using the carbonaceous materials disclosed herein and methods described herein, it is possible to compound c. 20-gram scale, non-pelletized material with SBR. The composite material is reinforced relative to unfilled material (e.g., gum rubber). It has been demonstrated herein that blending carbonaceous material with N660 can achieve similar performance, if not superior performance. In particular aspects, 100% replacement of N660 with carbonaceous material in SBR rubber exhibited reinforcement relative to unfilled gum rubber.

### VI. Making Carbonaceous Material

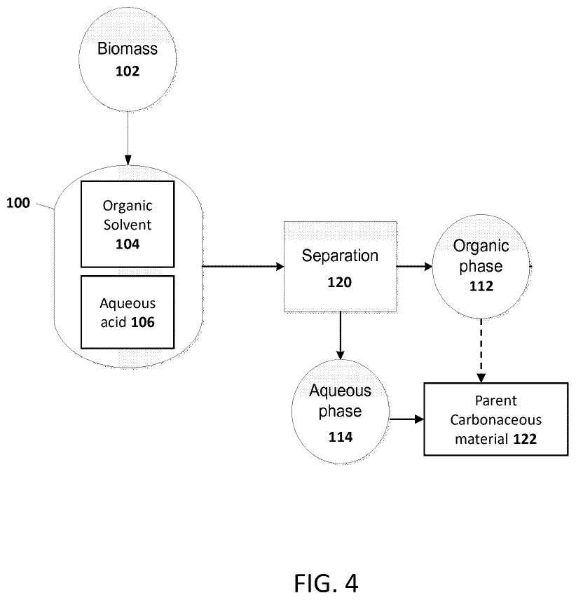

FIG. 4 shows a block diagram of an example system and method for converting a biomass feedstock into a carbonaceous material according to the present disclosure. In the example of FIG. 4, biomass 102 is added to reactor 100, and contacted with an organic solvent 104 and aqueous acid 106 (e.g., hydrochloric acid). Contents of the reactor 100 are heated and stirred at a reaction temperature suitable to convert at least a portion of cellulose and/or hemicellulose in the biomass into products such as furans and furan derivatives.

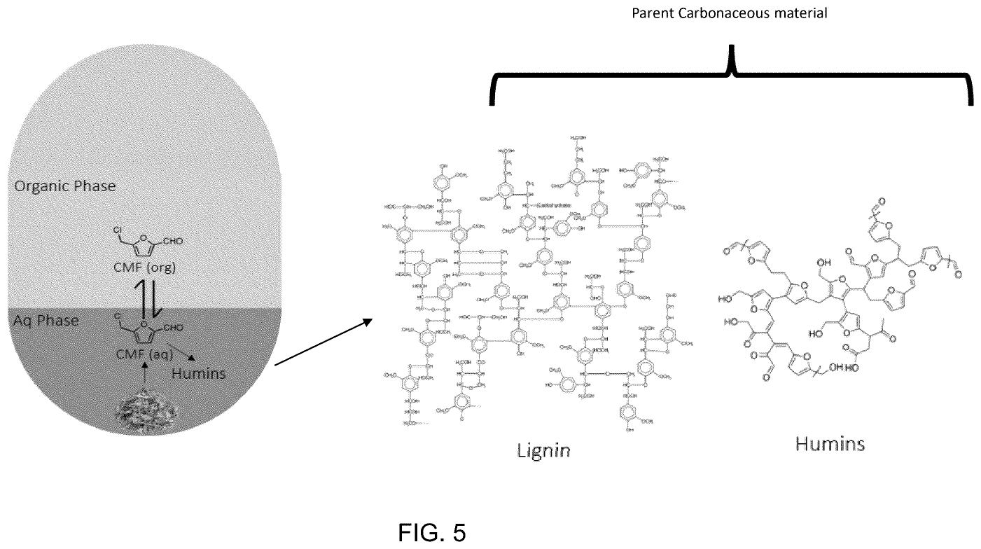

After the reaction is complete, in step 120, the reaction mixture is separated at a separation temperature into organic phase 112 and aqueous phase 114. The parent carbonaceous material 122, which can comprise unreacted biomass, insoluble humins, and other materials, remains behind with the aqueous phase 114. As described in more detail below, when the biomass 102 includes lignin, the parent carbonaceous material can additionally include lignin moieties as illustrated in FIG. 5.

### A. Feedstock

The feedstock used to produce the parent carbonaceous material generally refers to a starting material used to produce the parent carbonaceous material that is then converted to the carbonaceous material of the present disclosure. Suitable feedstock may include any materials that contain saccharides. In particular aspects, the feedstock comprises cellulosic biomass, such as lignocellulose and other cellulosic materials. Non-limiting examples of the feedstock can include glucose, glucans, cellulose, lignocellulose, hemicellulose, starch, sucrose, or any mixtures thereof.

In some aspects, the feedstock includes six-carbon (C6) saccharides and/or five-carbon (C5) monosaccharides. The terms “six-carbon saccharides” or “C6 saccharides” generally refer to saccharides in which a monomeric unit has six carbons. The terms “five-carbon saccharides” or “C5 saccharides” generally refer to saccharides in which a monomeric unit has five carbons. The feedstock may include monosaccharides, disaccharides, polysaccharides, or any mixtures thereof. In one aspect of the disclosure, the feedstock includes one or more C6 monosaccharides. In another aspect of the disclosure, the feedstock includes a disaccharide or polysaccharide comprising monomeric units having six carbon atoms. It should be understood that the monomeric units may the same or different.

In one aspect, the feedstock includes a monosaccharide. Examples of suitable monosaccharides include glucose, fructose, and any other isomers thereof. In another aspect, the feedstock includes a disaccharide. Examples of suitable disaccharides include sucrose. In yet another aspect, the feedstock includes a polysaccharide. Examples of polysaccharides include cellulose, hemicellulose, cellulose acetate, and chitin. In other aspects, the feedstock includes a mixture of monosaccharides, disaccharides, polysaccharides. For example, in one aspect of the disclosure, the feedstock may include glucose, sucrose, cellulose, or any combination thereof. In another aspect of the disclosure, the feedstock includes glucans, starch (e.g., corn starch), cellulose, hemicellulose, another anhydrosugar, or any combination thereof.

In some aspects, the feedstock includes C6 saccharides selected from glucose, fructose (e.g., high fructose corn syrup), cellobiose, sucrose, lactose, and maltose, or isomers thereof (including any stereoisomers thereof), or any mixtures thereof. In one aspect, the feedstock includes glucose, or a dimer or polymer thereof, or an isomer thereof. In another aspect, the feedstock includes fructose, or a dimer or polymer thereof, or an isomer thereof. In another aspect of the disclosure, the feedstock is a saccharide composition. For example, the saccharide composition may include a single saccharide or a mixture of saccharides such as fructose, glucose, sucrose, lactose and maltose.

Feedstock suitable for use in producing the parent carbonaceous material may also include derivatives of the sugars described above. In some aspects, the feedstock may comprise aldoses, ketoses, or any mixtures thereof. In some aspects, the feedstock includes C6 and/or C5 aldoses, C6 and/or C5 ketoses, or any mixtures thereof.

In some aspects, the feedstock includes an aldose, or any polymers thereof. In one aspect of the disclosure, the feedstock includes a C6 aldose, or any polymers thereof. Examples of suitable aldoses include glucose. In another aspect of the disclosure, the feedstock includes polyaldoses.

In other aspects, the feedstock includes a ketose, or any polymers thereof. In another aspect, the feedstock includes a C6 ketose, or any polymers thereof. Examples of suitable ketoses include fructose. In another aspect of the disclosure, the feedstock includes polyketoses.

In yet another aspect, the feedstock includes a mixture of C6 aldoses and C6 ketoses. For example, in one aspect of the disclosure, the feedstock may include glucose and fructose.

In some aspects, when the feedstock includes sugars, the sugars may be present in open-chain form, cyclic form, or a mixture thereof. Those in the art would recognize that, when the feedstock includes glucose, the open-chain form of glucose used may exist in equilibrium with several cyclic isomers in the reaction.

In other aspects, when the feedstock includes sugars, the sugars can exist as any stereoisomers, or as a mixture of stereoisomers. For example, in some aspects, the feedstock may include D-glucose, L-glucose, or a mixture thereof. In other aspects, the feedstock may include D-fructose, L-fructose, or a mixture thereof.

In one aspect of the disclosure, the feedstock includes hexose. Hexose is a monosaccharide with six carbon atoms, having the chemical formula C₄H₁₂O₆. Hexose may comprise an aldohexose or a ketohexose, or a mixture thereof. The hexose may be in open-chain form, cyclic form, or a mixture thereof. The hexose may comprise any stereoisomer, or mixture of stereoisomers. Suitable hexoses may include, for example, glucose, fructose, galactose, mannose, allose, altrose, gulose, idose, talose, psicose, sorbose, and tagatose, or any mixtures thereof.

The feedstock used to produce the parent carbonaceous material may be obtained from any commercially available sources. For example, one of skill in the art would recognize that cellulose and hemicellulose can be found in biomass (e.g., cellulosic biomass or lignocellulosic biomass). Accordingly, in some aspects, the feedstock comprises biomass, which can be any plant or plant-derived material made up of organic compounds relatively high in oxygen, such as carbohydrates, and also contain a wide variety of other organic compounds. As introduced above, some of these feedstocks (such as wood, grass, corrugated cardboard, etc.) also contain lignin. The biomass may also contain other materials, such as inorganic salts and clays.

Biomass may be pretreated to help make the sugars in the biomass more accessible, by disrupting the crystalline structures of cellulose and hemicellulose and breaking down the lignin structure (if present). Pretreatments can include, for example, mechanical treatment (e.g., shredding, pulverizing, grinding), concentrated acid, dilute acid, SO₂, alkali, hydrogen peroxide, wet-oxidation, steam explosion, ammonia fiber explosion (AFEX), supercritical CO₂ explosion, liquid hot water, and organic solvent treatments.

Biomass may originate from various sources. For example, biomass may originate from agricultural materials (e.g., corn kernel, corn cob, corn stover, rice hulls, peanut hulls, and spent grains), processing waste (e.g., paper sludge), and recycled cellulosic materials (e.g., cardboard, old corrugated containers/cardboard (OCC), old newspaper (ONP), and mixed paper). Other examples of suitable biomass may include wheat straw, paper mill effluent, newsprint, municipal solid wastes, wood chips, saw dust, forest thinnings, slash, miscanthus, switchgrass, sorghum, bagasse, manure, wastewater biosolids, green waste, and food/feed processing residues.

A combination of any of the feedstock described herein may also be used. For example, in one aspect of the disclosure, the feedstock may include glucose, corn kernel, and wood chips. In another aspect of the disclosure, the feedstock may include wood chips and cardboard. In yet another aspect of the disclosure, the feedstock may include bagasse and cardboard. In yet another aspect of the disclosure, the feedstock may include empty fruit bunches. In yet another aspect of the disclosure the feedstock may include corn starch and wood chips. In yet another aspect of the disclosure, the feedstock consists essentially of or consists of corn starch. In aspects where the feedstock consists essentially of corn starch, the feedstock does not comprise, or is free of, another type of biomass species from which a parent carbonaceous material can be derived.

### B. Acid

In some aspects, the acid used to produce the parent carbonaceous material is a halogen-containing acid. Such an acid has a formula HX, wherein X is a halogen. However, it will also be appreciated that any other suitable acids can be used. Other examples of suitable acids include a halogen-containing mineral acid or a halogen-containing organic acid. A mixture of acids may also be used. Some examples of suitable acids include hydrochloric acid, hydrobromic acid, nitric acid, phosphoric acid, sulfuric acid, or fluoroboric acid. A combination of any of the acids described herein may also be used.

Thus, the acid used herein may be obtained from any commercially available source, or be produced in situ from providing suitable reagents to the reaction mixture. For example, hydrochloric acid may be produced in situ in the reaction mixture by providing sulfuric acid and sodium chloride to the reaction mixture.

In other aspects, the acid fed into the reactor or the reaction mixture is a gaseous acid. For example, at least a portion of such gaseous acid may be dissolved, or partially dissolved, in the reaction mixture to produce an aqueous acid.

The concentration of the acid used herein may vary depending on several factors, including the type of feedstock used. In some aspects, concentrated acid is used. For example, one of skill in the art would recognize that concentrated hydrochloric acid is 12 M. In other aspects, the acid used to produce the materials disclosed herein has a concentration less than 12 M, less than or equal to 11.5 M, less than or equal to 11 M, less than or equal to 10.5 M, less than or equal to 10 M, less than or equal to 9.5 M, less than or equal to 9 M, less than or equal to 8.5 M, less than or equal to 8 M, less than or equal to 7.5 M, less than or equal to 7 M, less than or equal to 6.5 M, less than or equal to 6 M, less than or equal to 5.5 M, less than or equal to 5 M, less than or equal to 4.5 M, less than or equal to 4 M, less than or equal to 3.5 M, less than or equal to 3 M, less than or equal to 2.5 M, less than or equal to 2 M, less than or equal to 1.5 M, or less than or equal to 1 M; or between 0.25 M and 10 M, between 0.25 M and 9 M, between 0.25 M and 8 M, between 0.25 M and 7 M, between 0.25 M and 6 M, between 0.25 M and 5 M, between 0.5 M and 10 M, between 0.5 M and 9 M, between 0.5 M and 8 M, between 0.5 M and 7 M, between 0.5 M and 6 M, between 0.5 M and 5 M, between 1 M and 10 M, between 1 M and 9 M, between 1 M and 8 M, between 1 M and 7 M, between 1 M and 6 M, between 1 M and 5 M, between 1 M and 4 M, or between 2 M and 4 M.

### C. Salt

A salt is optionally used in the production of the parent carbonaceous material used to arrive at the disclosed carbonaceous material. The salt may comprise one or more inorganic salts and/or one or more organic salts. An “inorganic salt” generally refers to a complex of a positively charged species and a negatively charged species, where neither species includes the element carbon. An “organic salt” generally refers to a complex of a positively charged species and a negatively charged species, where at least one species includes the element carbon.

The selection of the salt used may vary depending on the reaction conditions, as well as the acid and solvent used. In some aspects, the salt is an inorganic salt. In some aspects, the salt is a halogen-containing acid. Examples of salts that may be used in certain aspects include lithium salts, sodium salts, potassium salts, rubidium salts, cesium salts, magnesium salts, and calcium salts. A combination of any of the salts described herein may also be used.

The concentration of the salt(s) may vary. In some aspects, the concentration of the salt(s) is greater than 5 M, greater than 6 M, greater than 7 M, greater than 8 M, greater than 9 M, or greater than 10 M; or between 5 M and 20 M, between 5 M and 15 M, between 5.5 M and 10 M, between 7 M and 10 M. or between 7.5 M and 9 M; or about 10 M, about 11 M, about 12 M, about 13 M, about 14 M, or about 15 M. In other aspects, the salt is present from about 0.1% to 50% (w/w) of the aqueous phase.

The salt used herein may be obtained from any commercially available source, or be produced in situ from providing suitable reagents to the reaction mixture. For example, certain reagents in the presence of hydrochloric acid may undergo ion exchange to produce the chloride salt used to produce the parent carbonaceous material.

### D. Solvent

In some aspects, a solvent is used in the method to produce the parent carbonaceous material. The solvent may be obtained from any source, including any commercially available sources.

Any suitable solvent that can form a liquid/liquid biphase in the reaction mixture may be used, such that one phase is predominantly an organic phase and a separate phase is predominantly an aqueous phase.

The solvent may also be selected based on dipole moment, which is a measure of polarity of a solvent. The dipole moment of a liquid can be measured with a dipole meter. In some aspects, the solvent used herein has a dipole moment less than 20.1 D, less than or equal to 20 D, less than or equal to 18 D, or less than or equal to 15 D.

The solvent may also be selected based on boiling point. In some aspects, the solvent has a boiling point of at least 110° C., at least 150° C., or at least 240° C.

The solvent may include one solvent or a mixture of solvents. For example, in some aspects, the solvent includes one or more alkyl phenyl solvents, one or more alkyl solvents (e.g., heavy alkyl solvents), one or more ester solvents, one or more aromatic solvents, one or more silicone oils, or any combinations or mixtures thereof. In other aspects, the solvent includes one or more hydrocarbons, one or more halogenated hydrocarbons, one or more ethers, one or more halogenated ethers, one or more cyclic ethers, one or more amides, one or more silicone oils, or any combinations or mixtures thereof.

In some aspects, the solvent includes para-xylene, mesitylene, naphthalene, anthracene, toluene, dodecylbenzene, pentylbenzene, hexylbenzene, and other alkyl benzenes (e.g., Wibaryl® A, Wibaryl® B, Wibaryl® AB, Wibaryl® F, WibaryI® R. Cepsa Petrepar® 550-Q, Cepsa Petrepar® 900-Q, Santovac® 5, Santovac® 7, Marlican®, Synnaph AB 3, Synnaph AB4), sulfolane, hexadecane, heptadecane, octadecane, icosane, heneicosane, docosane, tricosane, tetracosane, or any combinations or mixtures thereof.

It should be understood that the solvent may fall into one or more of the classes listed herein. For example, the solvent may include para-xylene, which is an alkyl phenyl solvent and an aromatic solvent.

In some aspects, the solvent includes water.

A combination or mixture of solvents may also be used. In some aspects, an ether solvent may be combined with one or more other types of solvents listed above.

The solvents used may vary depending on the type and amount of feedstock used. For example, in some aspects, the mass to volume ratio of feedstock to solvent is between 1 g and 30 g feedstock per 100 mL solvent.

It is further understood that any description of the solvents used to produce the carbonaceous material may be combined with any description of the acids and salts the same as if each and every combination were individually listed. For example, in some aspects, the acid is hydrochloric acid, the salt is lithium chloride or calcium chloride, or a combination thereof, and the solvent is an alkyl phenyl solvent.

### E. Reaction Conditions

As used herein, “reaction temperature” and “reaction pressure” refer to the temperature and pressure, respectively, at which the reaction takes place to produce the parent carbonaceous material.

In some aspects of the step to produce the carbonaceous material, the reaction temperature is at least 15° C., at least 25° C., at least 30° C., at least 40° C., at least 50° C., at least 60° C., at least 70° C., at least 80° C., at least 90° C., at least 100° C., at least 110° C., at least 115° C., at least 120° C., at least 125° C., at least 130° C., at least 135° C., at least 140° C., at least 145° C., at least 150° C., at least 175° C., at least 200° C., at least 250° C., or at least 300° C. In other aspects, the reaction temperature is between 110° C. and 300° C., between 110° C. to 250° C., between 150° C. and 300° C., or between 110° C. and 250° C.

In some aspects, the reaction pressure is between 0.1 atm and 10 atm. In other aspects, the reaction pressure is atmospheric pressure.

It should be understood that temperature may be expressed as degrees Celsius (° C.) or Kelvin (K). One of ordinary skill in the art would be able to convert the temperature described herein from one unit to another. Pressure may also be expressed as gauge pressure (barg), which refers to the pressure in bars above ambient or atmospheric pressure. Pressure may also be expressed as bar, atmosphere (atm), Pascal (Pa) or pound-force per square inch (psi). One of ordinary skill in the art would be able to convert the pressure described herein from one unit to another.

The reaction temperature and reaction pressure of the step to produce the carbonaceous material may also be expressed as a relationship. For example, in one aspect of the disclosure, reaction temperature T expressed in Kelvin and reaction pressure P expressed in psi, wherein 10<Ln [P/(1 psi)]+2702/(T/(1 K))<13.

The residence time will also vary with the reaction conditions and desired yield. Residence time refers to the average amount of time it takes to produce a parent carbonaceous material from the reaction mixture. In some aspects of the step to produce the parent carbonaceous material, the residence time is at least 360 minutes, at least 240 minutes, at least 120 minutes, at least 60 minutes, at least 30 minutes, at least 20 minutes, at least 10 minutes, at least 5 minutes, or at least 2 minutes.

### F. Isolation

In some aspects, provided is method of producing a carbonaceous material by: combining a feedstock, an acid and optionally a salt to form a reaction mixture; producing a parent carbonaceous material from at least a portion of the reaction mixture; and isolating the parent carbonaceous material. As discussed above, the parent carbonaceous material can include unreacted feedstock material, and may also include humins, carbohydrate moieties, and/or lignin moieties.

With reference again to FIG. 4, the parent carbonaceous material produced is isolated at step 122. Any suitable techniques known in the art may be employed to isolate the parent carbonaceous material, such as filtration and centrifugation. For example, solid-liquid separation techniques such as filtration and centrifugation may be used to isolate the carbonaceous material produced.

### G. Post-Treatment

In some aspects, the parent carbonaceous material 122 of FIG. 4 is post-treated to at least partially deoxygenate the parent carbonaceous material and provide the carbonaceous material. In some examples, post-treating the parent carbonaceous material comprises heat-treating the parent carbonaceous material at a suitable temperature to convert at least a portion of the parent carbonaceous material into the carbonaceous material.

In some aspects, heat-treating the parent carbonaceous material comprises heating the parent carbonaceous material at a temperature ranging from 300° C. to 1000° C. It will also be understood that the carbonaceous material can be heat treated at any other suitable temperature. Other examples of suitable temperatures can be less than 300° C. or more than 1000° C. Heat-treating the parent carbonaceous material at temperatures within this range (e.g., temperatures of at least 350° C. to 500° C.) can result in conversion of at least a portion of the parent carbonaceous material into a turbostratic-carbon-like structure.

In some aspects, the parent carbonaceous material is heat-treated in an inert atmosphere, for example, with argon or nitrogen. It should be understood, however, that, in some aspects, the argon or nitrogen atmosphere may have trace quantities of oxygen.

There are also specialty carbon black applications that require a more hydrophilic material and/or materials with a greater oxygen content. The carbonaceous material described herein is well-suited to fulfill these specifications. In some aspects, the carbonaceous material can be used to create fillers with different desired (e.g., intermediate) levels of oxygen-containing groups due to the high oxygen content existing in the parent carbonaceous material as produced (e.g., the parent carbonaceous material 122 of FIG. 4). This can be accomplished by modifying the heat-treating the parent carbonaceous material. In some aspects, the heat treatment is modified to be conducted at a relatively lower temperature and/or for less time than is used to deoxygenate the parent carbonaceous material, as described in more detail below.

In some aspects of the present disclosure, the carbonaceous material has a carbon content of greater than or equal to 85 wt. %, such as 85 wt. % to 100 wt. %, or 90 wt. % to 100 wt. %, or 95 wt. % to 100 wt. %. In some aspects, the carbonaceous material has a carbon content of greater than 90 wt. %, such as 91 wt. %, or 92 wt. %, or 93 wt. %, or 94 wt. %, or 95 wt. %, or 96 wt. %, or 97 wt. %, or 98 wt. %, or 99 wt. %. In some aspects, these carbon content values can be obtained by heat-treating a parent carbonaceous material at a temperature of 850° C. or higher (e.g., 850° C. to 1000° C.). For example, in some aspects, a southern pine (SP)-derived carbonaceous material heat-treated at 1000° C. has a carbon content ranging from 93-95%. In another exemplary aspect, a CS/HW-derived carbonaceous material has a carbon content ranging from 91-96%. The carbon content can be used as a proxy value for deoxygenation level and hydrophobicity, which can be tuned by altering the conditions of the heat treatment step.

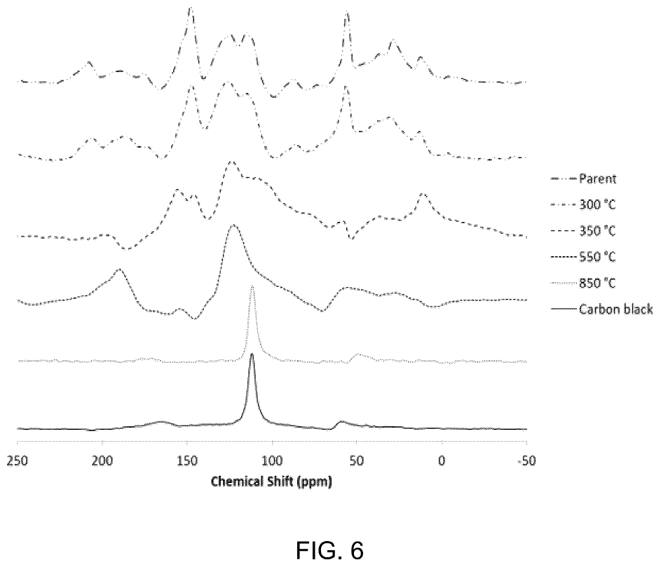

FIG. 6 shows cross polarization/magic angle spinning (CP/MAS) solid-state 13C NMR of carbonaceous material heat-treated at different temperatures under nitrogen gas. Abundant functional groups in the parent carbonaceous material initially produced (prior to heat treatment) have a strong influence on the chemical environment of carbon atoms within the parent carbonaceous material, leading to heterogenous spectra up to at least 550° C.

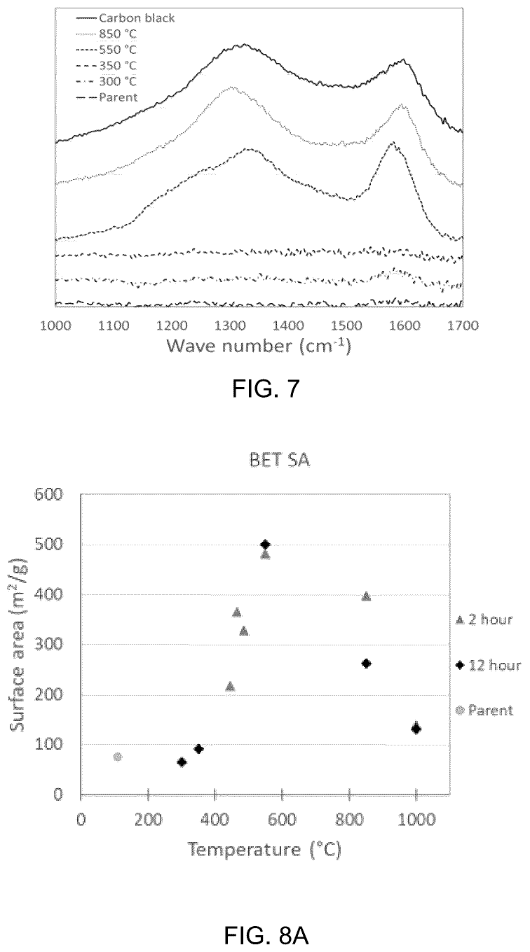

In some aspects, at least partial deoxygenation of the parent carbonaceous material to the carbonaceous material occurs between 350° C. and 550° C., wherein a turbostratic structure may be obtained. Formation of a turbostratic-type structure can be assessed using Raman spectroscopy, for example as illustrated by the data in FIG. 7. Looking at both Raman spectroscopy and 13CNMR, a carbonaceous material having an increased carbon structure/content that is closer to levels of N660 carbon black can be achieved at temperatures at or near 850° C.

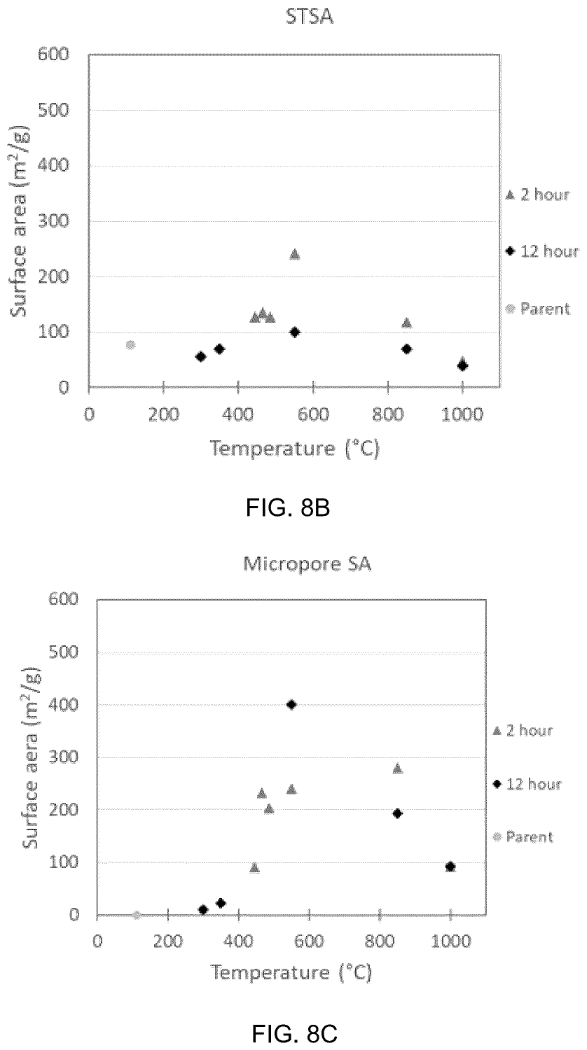

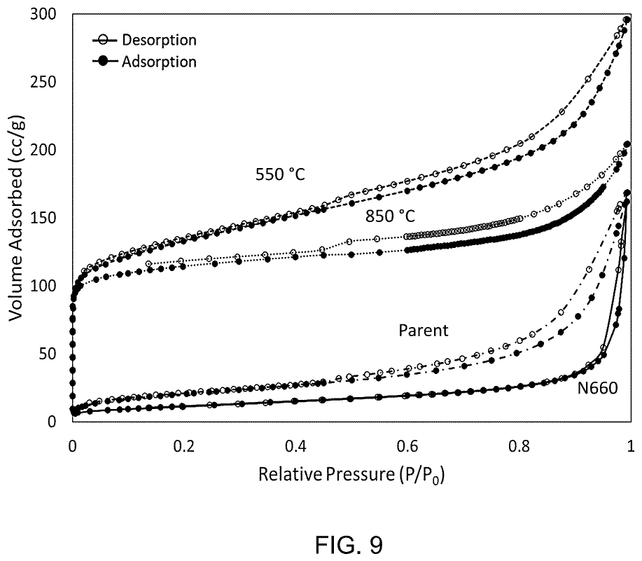

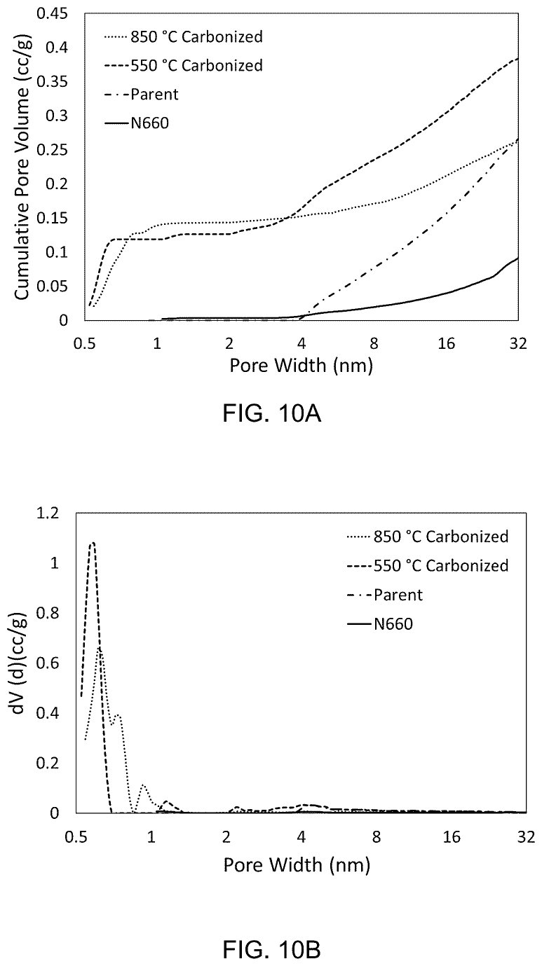

FIGS. 8A-8C show the formation and subsequent partial collapse of micropore structure as a function of temperature. This finding reveals that the carbonaceous material itself naturally activates (up to 500 m²/g) under relatively mild temperatures (c. 550° C.), and without the application of an activating agent. Nitrogen physisorption isotherms are shown in FIG. 9, along with pore size distribution and cumulative pore volume in FIGS. 10A-10B. Samples of carbonaceous material obtained from heat-treated parent material (namely at 550° C. and 850° C.) show high adsorption and low relative pressure, indicating high abundance of micropores, and hysteresis at medium to high relative pressure, indicating the presence of mesopores. Carbon black does not contain micropores or mesopores. Instead, carbon black's external faces primarily contribute to its surface area. Pore size distributions indicate that the micropores that develop are less than 1 nm in diameter. Cumulative pore volume indicates the presence of mesopores, but these do not appear to be ordered, as evidence by the lack of substantial peaks in the pore size distribution data between 2 and 30 nm.

### H. Additional Processing Steps

As described herein, the carbonaceous material according to the present disclosure is made by post-processing a parent carbonaceous material that is obtained from a biomass feedstock. A method for making the parent carbonaceous material is described in more detail below, along with features of the parent material. In addition to the post-processing described herein, the parent carbonaceous material produced may undergo one or more additional processing steps to provide the carbonaceous material of the present disclosure. For example, in some aspects, the carbonaceous material produced may be washed after heat-treating the parent carbonaceous material. In one aspect of the disclosure, the carbonaceous material produced may be washed with an acid wash, or a water wash, or a combination thereof. For example, in one aspect of the disclosure, the carbonaceous material can be washed with an acid. The acid used to wash the carbonaceous material produced may be referred to as a “wash acid” or acid wash. In some aspects, the wash acid is an aqueous acid. Suitable acids may include, for example, hydrochloric acid. The wash acid is not an activating agent and does not used to impregnate the carbonaceous material.

In other aspects, the carbonaceous material may be washed with an organic wash, an aqueous wash, brine, or a basic wash.

In other aspects, the carbonaceous material produced may be dried, either with or without washing the carbonaceous material as described above. For example, in one aspect of the disclosure, the carbonaceous material produced may be washed after heat treatment, followed by a drying step.

In some aspects of the present disclosure, an aggregate particle size of the carbonaceous material can be reduced through one or more physical processes, such as milling, sieving, shearing, cavitation, and the like. Examples of suitable milling methods include jet milling, ball milling, media milling, burr milling, hammer milling, or a combination thereof. Additional details regarding milling and applications of milled carbonaceous material are described in more detail below.

Furthermore, in some aspects, the carbonaceous material is combined with a pre-polymer material that is cured and/or hardened in the presence of the carbonaceous material to form a composite polymer composition. In some aspects, the pre-polymer material comprises (i) a mixture of styrene and butadiene; or (ii) isoprene. In this manner, the pre-polymer material forms an elastomer upon curing and/or hardening. Other examples of suitable materials include thermoplastic polymers and natural rubber. Other examples of rubber materials can include ethylene propylene diene monomer rubber and butyl rubber.

As introduced above, composite polymer materials can also be produced using a blend of two or more filler materials that are chemically distinct. For example, the carbonaceous material can be mixed with carbon black obtained from a non-biomass source to form a compound filler for a composite polymer. In some aspects, the carbonaceous material is present as a first filler material in an amount ranging from greater than 0 to 100 wt. % of the filler material, such as greater than 0 to 95 wt. %, greater than 0 to 90 wt. %, greater than 0 to 85 wt. %, greater than 0 to 80 wt. %, greater than 0 to 75 wt. %, greater than 0 to 70 wt. %, greater than 0 to 65 wt. %, greater than 0 to 60 wt. %, greater than 0 to 55 wt. %, greater than 0 to 50 wt. %, greater than 0 to 45 wt. %, or greater than 0 to 40 wt. %. For example, as described in more detail below, a blend of carbonaceous material and N660 carbon black in a weight ratio of 40:60 in a styrene-butadiene rubber (SBR) matrix results in a composite polymer material with a tensile strength of greater than or equal to 2500 psi (e.g., 2500 psi to 3500 psi, such as 2500 psi to 3000 psi), which is greater than or equal to a composite material filled by N660 carbon black alone. In some aspects, the tensile strength is measured using ASTM D 412. In additional aspects, the carbonaceous material of the present disclosure can have an elongation ranging from 200% to 600%, such as 300% to 600%, 400% to 600%, or 500% to 600%. In some aspects, the elongation ranges from 400% to 500%.

### VII. Overview of Several Aspects

Disclosed herein are aspects of a carbonaceous material produced from a biomass feedstock, the carbonaceous material comprising: a carbon content of greater than or equal to 85 wt. %; a surface area ranging from 150 m²/g to 500 m²/g; and an oil absorption value ranging from 50 g/100 g to 100 g/100 g.

In any or all of the above aspects, the biomass feedstock comprises a lignin-free material, a lignin-containing material, or a combination thereof.

In any or all of the above aspects, the biomass feedstock comprises cornstarch, a wood material, or a combination thereof.

In any or all of the above aspects, the biomass feedstock is cornstarch.

In any or all of the above aspects, the carbonaceous material further comprises a portion of unreacted biomass feedstock, a macromolecular furan derivative, a cellulose compound, a lignin-based and/or lignin-derived compound, or a combination thereof.

In any or all of the above aspects, the macromolecular furan derivative is a humin.

In any or all of the above aspects, the oil absorption value ranges from 65 g/100 g to 80 g/100 g.

In any or all of the above aspects, the carbonaceous material is in the form of a particulate material comprising primary particles having (i) a D50 value of 200 nm or larger, or (ii) a D50 value of 30 nm to 100 nm.

In any or all of the above aspects, the carbonaceous material is obtained from heat-treating a parent carbonaceous material at a temperature of 800° C. to 1000° C.

In any or all of the above aspects, the carbonaceous material is obtained from heat-treating a parent carbonaceous material at a temperature of 850° C.

In any or all of the above aspects, the carbonaceous material comprises less than 0.5 mg/kg of polycyclic aromatic hydrocarbons (PAHs).

In any or all of the above aspects, the carbonaceous material comprises less than 0.2 mg/kg of polycyclic aromatic hydrocarbons (PAHs).

Also disclosed herein are aspects of a composite polymer composition comprising: a polymer matrix; and a filler material dispersed within the polymer matrix, wherein at least a portion of the filler material comprises a first filler component that is the carbonaceous material of any or all of the above aspects.

In any or all of the above aspects, the filler material further comprises a second filler component that is chemically distinct from the first filler component.

In any or all of the above aspects, the second filler component comprises carbon black obtained from a non-biomass-based feedstock.

In any or all of the above aspects, the first filler component is present in an amount ranging from greater than 0 to 60 wt. %.

In any or all of the above aspects, the composite polymer composition has a tensile strength greater than or equal to 2500 psi.

In any or all of the above aspects, the polymer matrix comprises a thermoplastic polymer or an elastomer.

In any or all of the above aspects, the polymer matrix comprises one or more of styrene-butadiene rubber or natural rubber.

In any or all of the above aspects, the first filler component is the carbonaceous material according to any or all of the above aspects.

Also disclosed herein are aspects of a rubber-containing product, comprising the composite polymer composition of any or all of the above aspects.

In any or all of the above aspects, the rubber-containing product is a tire.

Also disclosed herein are aspects of a composition, comprising: a pre-polymer material; and a filler material dispersed within the pre-polymer material, wherein at least a portion of the filler material comprises a first filler component that is the carbonaceous material of any or all of the above aspects.

In any or all of the above aspects, the pre-polymer material comprises (i) a mixture of styrene and butadiene; or (ii) isoprene.

Also disclosed herein are aspects of a method of producing the carbonaceous material, the method comprising: obtaining a parent carbonaceous material from a biomass feedstock, the parent carbonaceous material comprising a portion of unreacted biomass feedstock, a macromolecular furan derivative, a cellulose compound, a lignin-based compound, or a combination thereof; and post-treating the parent carbonaceous material to at least partially deoxygenate the parent carbonaceous material to provide the carbonaceous material, wherein post-treating the parent carbonaceous material does not comprise treating the parent carbonaceous material with an activating agent.

In any or all of the above aspects, post-treating the parent carbonaceous material comprises heat-treating the carbonaceous material.

In any or all of the above aspects, heat-treating the parent carbonaceous material comprises heating the parent carbonaceous material at a temperature ranging from 300° C. to 1000° C.

In any or all of the above aspects, post-treating the parent carbonaceous material comprises converting at least a portion of the parent carbonaceous material to turbostratic carbon.

In any or all of the above aspects, the carbonaceous material is a particulate material and the method further comprises reducing an aggregate particle size of the carbonaceous material.

In any or all of the above aspects, reducing the aggregate particle size of the carbonaceous material comprises milling the carbonaceous material.

In any or all of the above aspects, milling comprises jet milling, ball milling, media milling, or a combination thereof.

In any or all of the above aspects, the method further comprises combining the carbonaceous material with a pre-polymer material; and curing and/or hardening the pre-polymer material in the presence of the carbonaceous material to form a composite polymer composition.

In any or all of the above aspects, forming the composite polymer composition comprises forming a rubber-containing product.

In any or all of the above aspects, the carbonaceous material comprises: a carbon content of greater than or equal to 85 wt. %; a surface area ranging from 150 m²/g to 500 m²/g; and an oil absorption value ranging from 50 g/100 g to 100 g/100 g.

### VIII. Examples

Aspects of the present teachings can be further understood in light of the following examples. While these examples were used in experimental demonstrations, a person of ordinary skill in the art will realize that the present embodiments are not limited to either these small molecules or molecular weight ranges and the teachings herein enable a person of ordinary skill in the art to make and use a variety of carbonaceous materials.

Synthesis of wet parent carbonaceous material. The biomass to carbonaceous material reactions occurred in a pilot 80-gallon reactor, with a target reaction temperature range of 135-145° C. and reaction times of 10-24 minutes. Target concentrations of the aqueous phase were typically 2M HCl, 5.5 CaCl₂), and 13M total CI. Feedstock mass fractions in the aqueous phase typically range from 10-23 wt % and consist of both single feedstocks (cornstarch or wood only) or blends of feedstocks (cornstarch and wood combined). The “aqueous phase” is defined as total water, CaCl₂), and HCl in the reactor. Organic to aqueous ratios ranged from 1.6 to 2.2. Note that both hardwoods and softwoods of various species of wood have been tested. Process steps are similar with variations occurring in the specific amounts of raw materials added.

Drying and carbonization. 56 kg of wet parent carbonaceous material at 80% wet basis (% w.b.) moisture content was placed in a furnace system. The system underwent nitrogen purge cycles to inert the furnace environment. Then, nitrogen was introduced into the system at a set flow rate (50 stand liters per minute (slpm)) and a slight positive pressure was maintained (760-860 torr). The system was heated up to 175° C. at 2.5° C./min followed by a 12-hour isothermal period for the drying step. The system was then heated up to 200° C. at 0.2° C./min followed by a 2-hour isothermal period to confirm the material had dried. The system was then heated up to 530° C. at 2.75° C./min followed by 2 hours of isothermal hold. The system was then ramped to 1000° C. at 7° C./min with a 4-hour isothermal hold to ensure complete carbonization. The system was turned off and equipment was allowed to cool to ambient temperature, which took roughly 12 hours.

Jet-milling. In examples herein, 200 to 1200 g of carbonaceous material was fed to an alpine jet-mill at 1 to 5 kg/hr. Grind gas pressures of 70 to 110 psi and classifier speeds of 12,000 to 22,000 rpm were employed. A two-stage particle-collection system was employed, consisting of a cyclone and baghouse. Both the cyclone and baghouse fractions were collected and tested separately. It should be recognized that these conditions may depend on the mill used. For example, using larger feed rates with a mill having a larger classifier at different grind gas pressures and/or lower speeds may be used.

Rubber compounding. Compounding was performed using the following ASTM standards: ASTM D 3182: Weighing & Mixing (TPE/Rubber & Plastic Blends); ASTM D 5289: Vulcanization Using Rotorless Cure Meters (MDR)—Rheometer; ASTM D 412: Original Physicals-Tensile Stress & Strength for Rubber; ASTM D 3182: Molding & Curing Standard Plaques or Slabs 6″ x 6; and ASTM D 5992: DMA—Metravib-Strain sweep at room temperature. Cure packages were employed per Table 1A.

TABLE 1A
Cure packages for rubber compounds.

| | | | Wt. % in the |
|---|---|---|---|
| Material | Role | phr | compounded rubber |
| SBR | Rubber | 100 | 63.8 |
| Zinc Oxide | Activator system | 3.00 | 1.9 |
| Stearic acid | Activator system | 1.00 | 0.6 |
| TBBS | Accelerator | 1.00 to 1.90 | 0.6 |
| Sulfur | Cross-linking | 1.75 | 1.1 |
| | agent | | |
| Carbon black | Filler | 50.0 | 31.9 |
| (N660) or | | | |
| carbonaceous | | | |
| material | | | |

NMR: ¹³C-enriched D-glucose was purchased from Cambridge Isotope Laboratory, Inc (CAS: 110187-42-3). ¹³C-enriched hybrid poplar (Populus alba×grandidentata) were obtained as a gift from Professor Jenny Mortimer from Joint BioEnergy Institute, USA. Young poplar cuttings with roots (4 weeks old) were transferred into a 12 L plastic container containing 11 L of Hoagland's nutrient solution pH 6.0. The ¹³C enrichment of the poplar biomass was done in a self-constructed growth chamber with a 13C atmosphere and controlled growing conditions (28° C., 70% humidity, 155 μmol m⁻² s⁻¹, 18 h light). Poplars were grown in the ¹³C growth chamber for 68 days to harvest.

GC headspace vials with crimp caps were used to conduct the reactions. Two separate vials were loaded with ¹³C enriched glucose (269 mg) and ¹³C enriched lignocellulosic biomass (245 mg), respectively, together with identical stir-bars. Brine/acid solution (1.25 mL) and toluene (2.00 mL) were added. The vials were tightly capped and placed into a heating block set to 130° C. behind a blast-shield. The stir-rate was set at 1000 rpm and the vials were heated for 22.5 min. The reaction was quenched an ice-water bath for rapid cooling. No weight loss was measured (<0.005 g) indicating there was no material leak from the vials during the reaction period. Reaction slurry was filtered through a filter funnel with a 10 micron polyethylene frit (Chemglass), and solid products were recovered and washed three times with 5 mL toluene and three times with 5 mL water. The solid products were then transferred into an aluminum pan covered with aluminum foil and transferred into a 90° C. oven for drying about 48 h. Later, the solid products were directly packed into a solid-state NMR rotor to investigate the molecular structure.

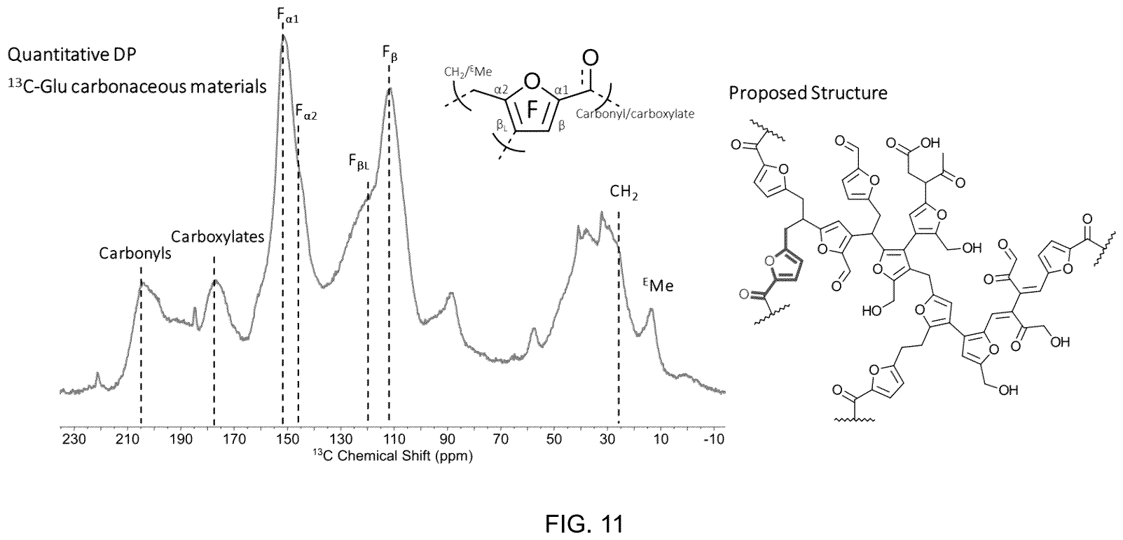

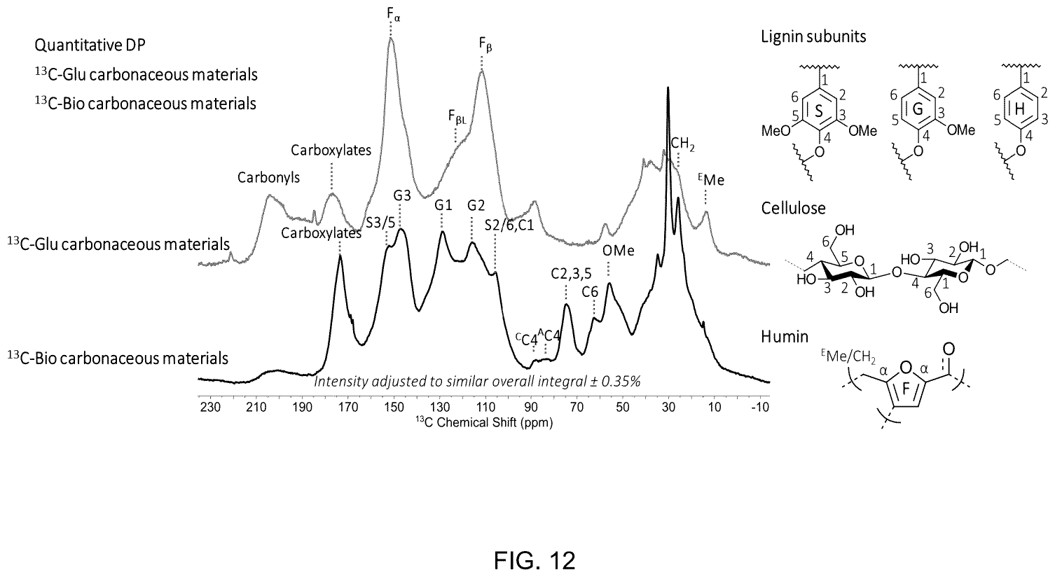

In the examples of FIG. 11 and FIG. 12, ¹³C enriched glucose and ¹³C enriched poplar biomass were reacted side-by-side to generate parent carbonaceous material for parallel comparison. According to the quantitative one-dimensional (1D) ¹³C direct-polarization (DP) ssNMR spectrum illustrated in FIG. 11, ¹³C-enriched-glucose-derived parent carbonaceous material (13C-Glu-HTC) shows dominant characteristic chemical shifts at 151.1 ppm, 144.7 ppm, 121.3 ppm and 111.5 ppm, which represents the two a-carbons, linked β-carbon and β-carbon of the furanic subunits. Carbonyl and carboxylate groups are also detected at chemical shift regions, 210-190 ppm and 183-167 ppm respectively. Aliphatic carbon linkages of the furanic subunits are detected at chemical shift region of 53-10 ppm.

On the other hand, FIG. 12 shows the quantitative 1D ¹³C DP ssNMR spectrum of ¹³C-enriched-poplar-biomass-derived parent carbonaceous material (¹³C-Bio-HTC), which has different dominant chemical shifts compared to the ¹³C-Glu-HTC. The aromatic region of the spectrum of the 13C-Bio-HTC is dominant with the characteristic chemical shifts representing the arene ring of lignin subunits, such as 153.1 ppm, 146.5 ppm, 128.8 ppm, 115.6 ppm, 105.3 ppm, and 56.0 ppm for S3/5, G3, G1, G2, S2/6, and methoxyl carbon. The ¹³C-Bio-HTC also shows a significant peak at the carboxylate carbon chemical shift region, but the dominant chemical shift is slightly different from the carboxylate carbons from the ¹³C-Glu-HTC. Additionally, the ¹³C-Bio-HTC does not register as strongly in the carbonyl carbon region as compared to ¹³C-Glu-HTC, which may indicate that little or no humin is present in the ¹³C-Bio-HTC.

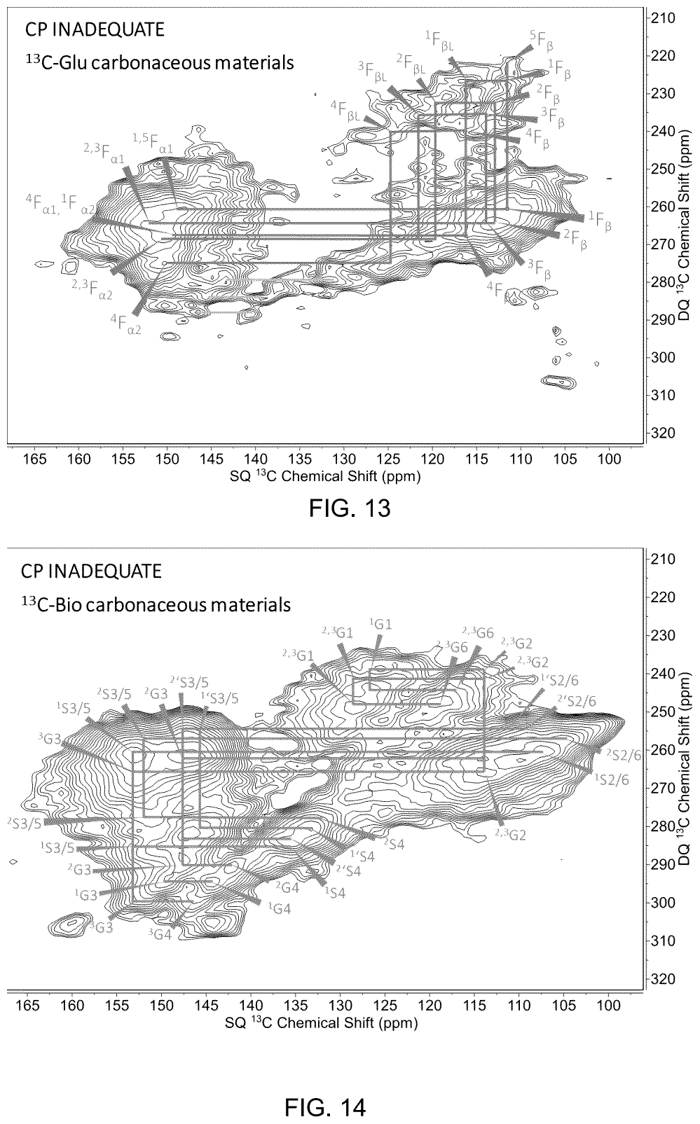

Furthermore, 2D 13C-13C correlated CP-INADEQUATE NMR experiments were also conducted on both ¹³C-Glu-HTC and ¹³C-Bio-HTC (FIGS. 13 and 14, respectively) to gain better resolution on the heavily overlapped peaks at the aromatic regions. These provide additional evidence on the distinct details on molecular structure of ¹³C-Glu-HTC and ¹³C-Bio-HTC. The CP-INADEQUATE spectrum of the ¹³C-Glu-HTC shows five dominant types of furan structural environments, without significant evidence of arene ring structures. However, the molecular structure of the ¹³C-Bio-HTC is dominant by seven identified lignin-derived arene ring structures (3 types of G units, 2 types of S units, and 2 types of oxidized S units) with no furan structure observed. This is consistent with results indicated by the 1D spectra of FIGS. 5-6.

FIG. 6 shows 1-D CP MAS solid-state ¹³C NMR spectra of examples of carbonaceous material obtained from a post-treated parent carbonaceous material, particularly a parent material that has been heat-treated at different temperatures. The spectra provide a broad indicator of the relative abundance of heteroatoms (e.g., oxygen) in the carbonaceous material. Heat-treating the carbonaceous material for the same time at a higher temperature results in greater deoxygenation of the carbonaceous material than heat-treating for the same time at a lower temperature. Deoxygenation is indicated by the relative smoothing of the NMR spectrum as chemical diversity of the carbonaceous material decreases and remaining carbonaceous material is converted into turbostratic carbon. In representative examples, the oxygen content was modified to values indicated in Table 1B.

TABLE 1B
Element levels

| Temperature | SP C | SP H | SP O | CS C | CS H | CS O |
|---|---|---|---|---|---|---|
| (° C.) | Level | Level | level | Level | Level | level |
| 550 | 85.02 | 2.68 | 8.21 | 84.594 | 2.729 | 6.48 |
| 850 | 93.09 | 0.79 | 1.64 | 85.925 | 0.858 | 3.37 |

The molecular structures of parent carbonaceous materials generated from lignin-free feedstock and lignocellulosic biomass feedstock were investigated respectively by magic angle spinning (MAS) ¹³C solid state nuclear magnetic resonance (ssNMR). Lignocellulosic biomass enriched with ¹³C was employed to produce parent carbonaceous material whose molecular structure can be directly probed by ssNMR. The parent carbonaceous material generated from a lignin-containing feedstock has a distinct molecular structure from the parent carbonaceous material generated from lignin-free feedstocks, such as glucose and corn starch. The molecular structure of parent carbonaceous material derived from lignin-free feedstocks is mainly composed of humins, which are dominated by furanic subunits with aliphatic linkages and carbonyl and carboxylate groups, as illustrated in FIG. 11. In contrast, the molecular structure of parent carbonaceous material derived from lignin-containing biomass is dominated by lignin-based moieties, such as the arene ring subunits illustrated in FIG. 12. These lignin-based moieties may indicate the presence of unreacted lignin, lignin degradation products, lignin-based moieties with modified interunit linkages, or a combination thereof.

Intrinsic surface activity of the carbonaceous materials of the present disclosure is beneficial in various specialty applications, such as coating and inks. Certain functional surface activity may impart improved reinforcement relative to furnace carbon black. This may be beneficial to overcome the lower-complexity structure of the carbonaceous materials disclosed herein (as the structure of carbon black provides reinforcement with rubber chain entanglement in the free volume of carbon black aggregate). In addition, rCB (reclaimed carbon black) has certain limitations due to high ash content as compared to the disclosed carbonaceous materials. High ash may contain more silica and zinc, lowering the tear strength of reinforced rubber.

FIG. 7 shows Raman spectra of the carbonaceous material of FIG. 6 that was obtained from the post-treatment (e.g., heat-treatment under an inert gas at different temperatures). The Raman spectra indicate that the carbonaceous material transitions from a resin to a turbostratic carbon structure between 350-550° C.

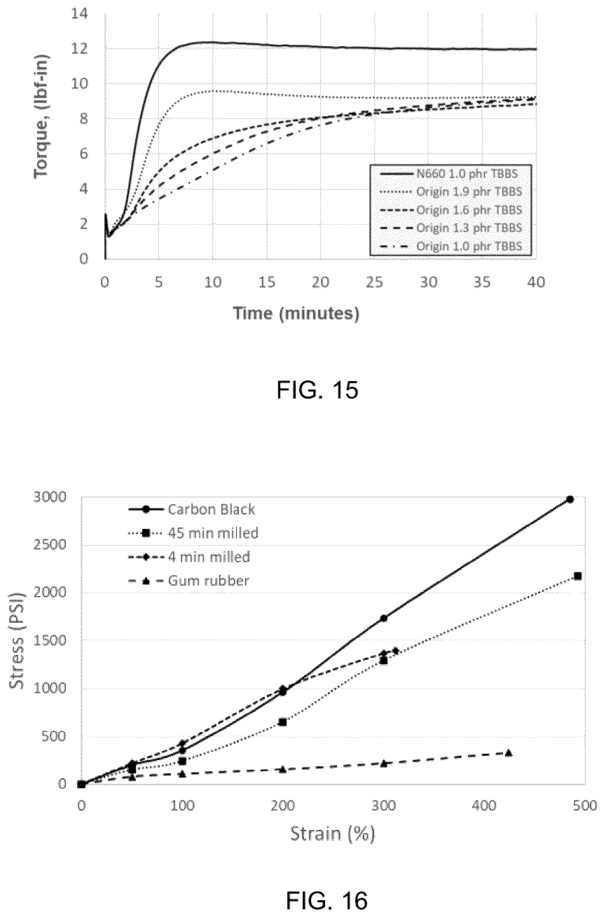

In one example, the carbonaceous material was dry media milled to produce a first set of carbon black replacement samples. The carbonaceous material was compounded with SBR using a cure package described in Table 1C, provided in examples of the present disclosure. In some aspects, a marching modulus was observed, which could indicate that the accelerator loading might be too low. The accelerator used was N-tert-butyl-benzothiazole sulfonamide (TBBS). Without being limited to a single operating theory, it is posited that marching modulus could be due to either the microporosity of heat-treated material (resulting in physisorption of TBBS), or due to the abundance of oxygen-containing functional groups (causing neutralization and/or chemical adsorption of the TBBS). FIG. 15 shows MDR rheology of SBR curing with different levels of TBBS. It was found that 1.9 phr TBBS gave similar T90 cure time to that of N660 with a “typical” curing profile. As such, 1.9 phr TBBS was used when compounding the carbonaceous material.

TABLE 1C
Cure packages for carbonaceous material (CM).

| | | phr | phr |
|---|---|---|---|
| Material | Role | (N660) | (CM) |
| SBR | Rubber | 100 | 100 |
| Zinc Oxide | Activator system | 3.00 | 3.00 |
| Stearic acid | Activator system | 1.00 | 1.00 |
| TBBS | Accelerator | 1.00 | 1.90 |
| Sulfur | Cross-linking agent | 1.75 | 1.75 |
| Carbon black | Filler | 50 | 50 |

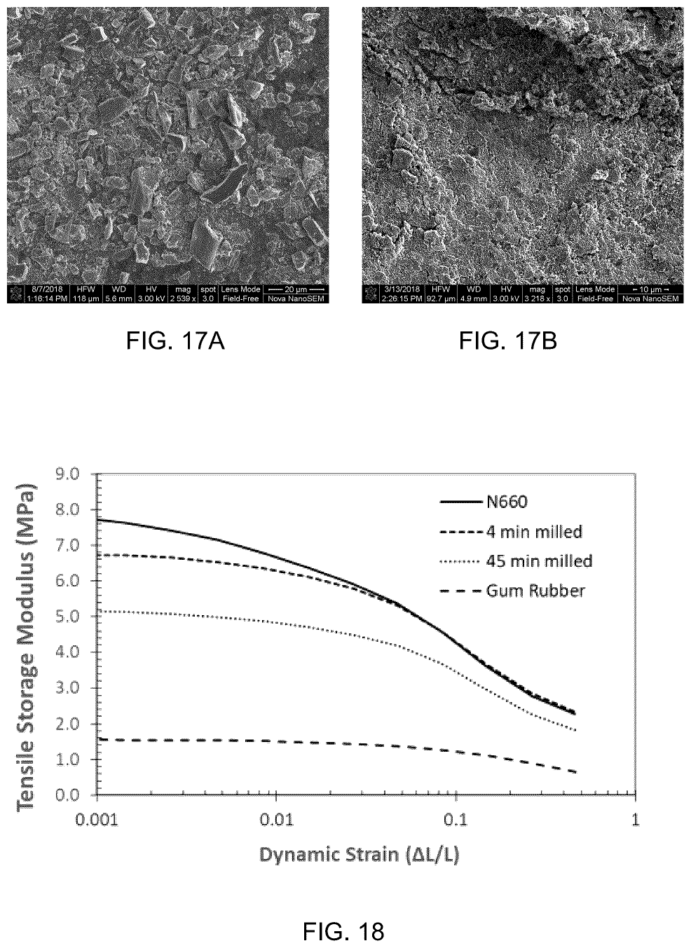

Routine testing of carbonaceous material as a filler could commence once the cure package was determined. FIG. 16 shows tensile stress/strain curves for N660, gum rubber, and two carbonaceous material samples dry media milled for different durations. It was found both carbonaceous material samples endured significantly higher stress than gum rubber, indicating that these samples are reinforcing the rubber. Table 2 shows compounding data comparing 4- and 40-minute milled carbonaceous material as well as N660. At low strain (≤200%), the sample milled for 4 minutes endured higher stress than the 40-minute sample. However, in some aspects, the 4-minute sample failed at relatively low strain. The 40-minute milled sample resulted in lower stress than N660 throughout the test, but had comparable elongation at break in certain aspects. Without being limited to a single theory, the reason for the difference in performance between the two carbonaceous material samples might be due to aggregate size and structure. As shown in FIG. 17A, the maximum size of the 4-minute milled carbonaceous material is around 26 microns. In the 40-minute milled sample, the maximum particle size visible in FIG. 17B is 8 microns. By comparison, N660 carbon black has aggregate particle D90s around 0.4 microns. It was surprising that an 8-micron particle would have a tensile strength comparable to that of N660. In some examples, particles that are over 1 micron might cause point defects in a rubber matrix, leading to poor elongation at break (as observed with some aspects of the 4-minute milled sample). Without wishing to be bound by theory, it could be that the 40-minute milled sample has been milled thoroughly enough that tube-like structures remaining from the wooden feedstock are converted to shards (e.g., walls of the tubes) and that, due to their plate-like morphology, are sheared apart during the rubber/carbonaceous material mixing process.

TABLE 2
SBR compounding data for N660 and heat-treated carbonaceous
material media milled at different times

| | Stress @200% | Elongation at | Tensile | OAN | SEM max particle | |
|---|---|---|---|---|---|---|
| Sample | Strain (psi) | break (%) | strength (psi) | (g/100 g) | size (micron) | |
| N660 | 959 | 485 | 2973 | 90 | <0.4 | μm |
| 4 min | 996 | 312 | 1390 | 97 | <26 | μm |
| 40 min | 650 | 493 | 2173 | 59 | <8 | μm |

Table 2 shows that the OAN structure of the 4-minute milled sample is close to that of N660 (97 compared to 90 g oil/100 g carbon, respectively). The 40-minute milled sample has an OAN of 57 g oil/100 g carbon. The larger structures within the 4-minute milled sample are likely why it has good reinforcement (stress) at lower strain, and why the 40-minute milled sample has lower reinforcement throughout the entire stress/strain range. FIG. 18 shows dynamic modulus data on these samples. The relatively high storage modulus of the 4-minute milled sample indicates a strong filler-filler interaction, likely due to the higher particle structure.

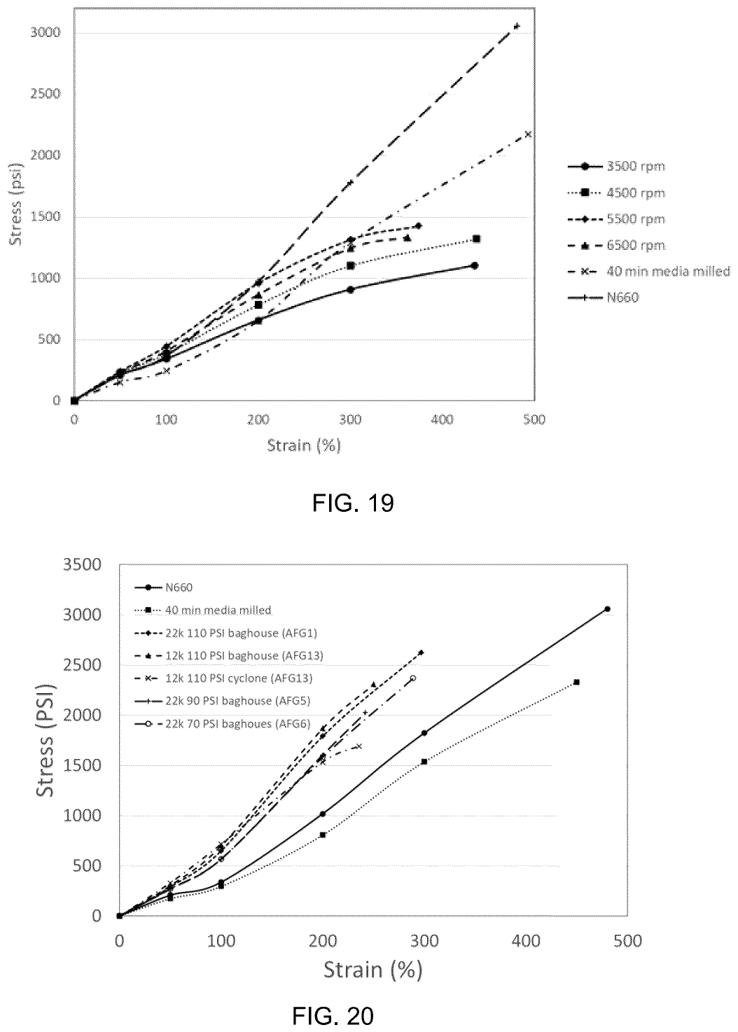

Other processes for particle size reduction were explored. In particular, opposed-air jet mills (e.g., alpine mills) were used to mill heat-treated carbonaceous material. The tensile stress strain data from one attempt to compound SBR with carbonaceous material produced form alpine jet milling is shown in FIG. 19. The RPM speeds indicate the classifier speed. Some samples exhibited relatively poor tensile strength and elongation at break. These samples were taken from a cyclone of the milling apparatus only, and it was likely that the particle size distribution was too narrowly centered (around approximately 8 microns).

A different alpine mill system was tested, and both the cyclone and baghouse material was collected. Baghouse material can be used as it can be finer (and potentially contain a higher fraction of primary particles) than the cyclone material. A design of experiment (DOE) was performed by varying the chamber pressure and air classifier speed. The resulting baghouse and cyclone particle size and fractions are shown in Table 3. The baghouse particle size did not appear to be significantly affected by the grinding conditions. However, both the size of material in the cyclone and overall fraction that ended up in the baghouse were affected by the milling conditions. With higher air classification speeds, the D90 in the cyclone was smaller and the fraction of baghouse material was larger. This is because the classifier speed largely dictates to what extent the particles are ground (higher classification speeds will result in a finer grind). The cyclone can only arrest particles out of the air down to a certain size. Therefore, typically, the more the material is ground, the smaller the large end of the particle size (D90) of the classifier particle size distribution will be, and higher the fraction of material that will be too small for the cyclone to separate (and thus are collected in the baghouse). Since the cyclone D90 is controlled by the geometry of the cyclone itself, the particle size of the baghouse D90 is relatively unchanged as a function of classifier speed.

TABLE 3
Alpine jet mill DOE results

| Pressure | Speed | D90 | D90 BH | Baghouse |
|---|---|---|---|---|
| (PSI) | (rpm) | (μm) | (μm) | fraction |
| 110 | 22000 | 6.41 | 2.69 | 0.302 |
| 90 | 22000 | 5.76 | 2.69 | 0.225 |
| 70 | 22000 | 5.47 | 3.12 | 0.255 |
| 90 | 17000 | 7.19 | 3.07 | 0.210 |
| 110 | 12000 | 12.21 | 3.64 | 0.149 |
| 70 | 12000 | 11.8 | 3.46 | 0.139 |

Several of the samples shown in Table 3 were compounded with SBR using the cure package shown in Table 1C. The resulting tensile stress/strain curves are shown in FIG. 20 and other compounding data are shown in Table 4. The cyclone material exhibited high low strain reinforcement compared to those used in the first example of alpine jet milling. All samples showed relatively high low strain reinforcement and relatively lower tensile strength. They also all showed relatively high hardness, indicating that the optimal loading is likely less than the 50 phr used in these experiments. These data seem to confirm that the milling conditions may not affect the properties of the baghouse material. There was no trend in terms of elongation and tensile strength vs. classifier speed or chamber pressure. The variation observed may be due to experimental error. The cyclone material does appear to exhibit different properties, as it has the lowest elongation at break, the lowest tensile strength, and curves down as it fails.

TABLE 4
SBR compounding data with jet-milled carbonaceous material.

| | | | | | Tensile | | Bound |
|---|---|---|---|---|---|---|---|
| | Pressure | Speed | D90 | Hardness | strength | Elongation | rubber |
| | (PSI) | (rpm) | (μm) | (Shore A) | (PSI) | (%) | (%) |
| AFG 1 BH | 110 | 22000 | 2.58 | 72 | 2627 | 297 | 44.3 |
| AFG 5 BH | 90 | 22000 | 2.69 | 70 | 2026 | 242 | 44.7 |
| AFG 6 BH | 70 | 22000 | 3.12 | 70 | 2369 | 289 | 45.5 |
| AFG 13 BH | 110 | 12000 | 3.64 | 71 | 2306 | 297 | 44.1 |
| AFG 13 Cy | 110 | 12000 | 12.21 | 72 | 1691 | 250 | 34.4 |
| N660 | N/A | N/A | D90 < 0.4 | 63 | 3059 | 480 | 41.7 |
| 40 min PBM | N/A | N/A | Unknown | 63 | 2329 | 450 | 51.4 |
| SP | | | | | | | |

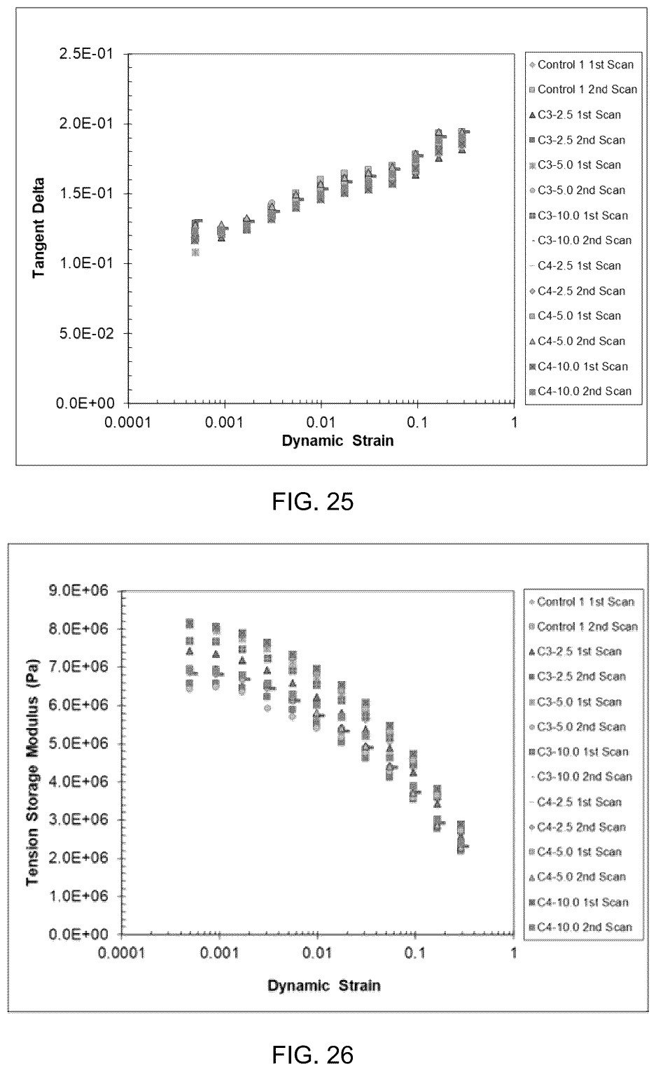

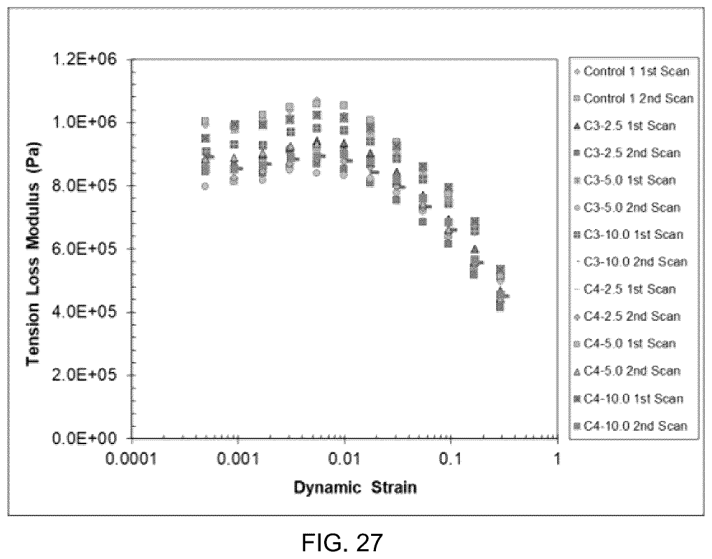

For example, baghouse and cyclone material from Table 3 were taken and blended with N660 carbon black obtained from a non-biomass-based feedstock (e.g., a fossil fuel feedstock) during compounding at 2.5, 5, and 10 phr (5, 10, and 20 wt. % replacement of N660). These batches were compounded using the cure package shown in Table 1C (e.g., with 1.0 phr TBBS accelerator). The results from those experiments are shown in FIGS. 22-24, as well as Table 5. When baghouse material was used to replace up to 20 wt. % N660 showed near identical performance to that of pure N660 in terms of stress/strain, tensile strength, elongation at break, hardness, bound rubber, hysteresis loss, and dynamic loss and storage modulus. See FIGS. 25-27. This demonstrates that this pedigree of carbonaceous material could be developed into a partial drop-in replacement for N660. The cyclone material had tensile strength values that were slightly less than N660 for the 10 and 20 wt. % replacement values. This was a surprisingly unexpected result because it would be expected that the tensile strength of the sample using the cyclone material would be poor.

TABLE 5
SBR compounding data with blends of N660
and jet-milled carbonaceous material.

| | | Tensile | | Bound |
|---|---|---|---|---|
| | Hardness | strength | Elongation | rubber |
| | (Shore A) | (PSI) | (%) | (%) |
| AFG 13 BH 5% | 65 | 2978 | 432 | 41.9 |
| AFG 13 BH 10% | 66 | 2949 | 432 | 42.6 |
| AFG 13 BH 20% | 67 | 2955 | 467 | 42.89 |
| AFG 13 BH 20% (avg) | 68 | 2856 | 421 | 42.29 |
| AFG 13 BH 30% | 65 | 2913 | 407 | 44.42 |
| AFG 13 BH 40% (avg) | 69 | 3090 | 433 | 43.88 |
| AFG 13 BH 100% | 76 | 2558 | 211 | 45.4 |
| AFG 13 CY 5% | 66 | 2775 | 418 | 42.1 |
| AFG 13 CY 10% | 67 | 2398 | 397 | 41.6 |
| AFG 13 CY 20% | 66 | 2593 | 470 | 41.5 |
| AFG 13 CY 100% | 75 | 1747 | 246 | 40.5 |
| N660 | 65 | 3000 | 455 | 41.87 |

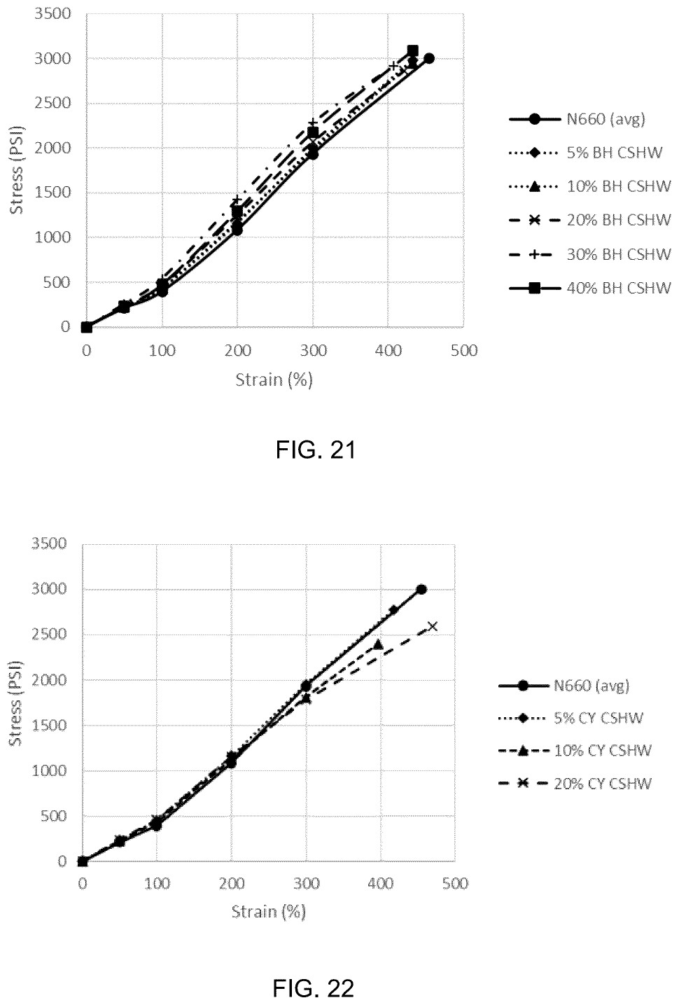

FIGS. 21, 22, and Table 5 show that baghouse (BH) heat-treated and jet-milled carbonaceous material (in this case, from cornstarch/hardwood (CS/HW, 65%/35%), heat treated at 1000° C.) can match the performance of N660 when blended with and replacing up to 40% of N660. These were all created using the same cure package, that is the same amount of TBBS [1 parts per hundred rubber (phr)], the same amount of filler (50 phr), etc. Replicates were included for the N660, 20%, and 40% samples, which are denoted by their average (“avg”).

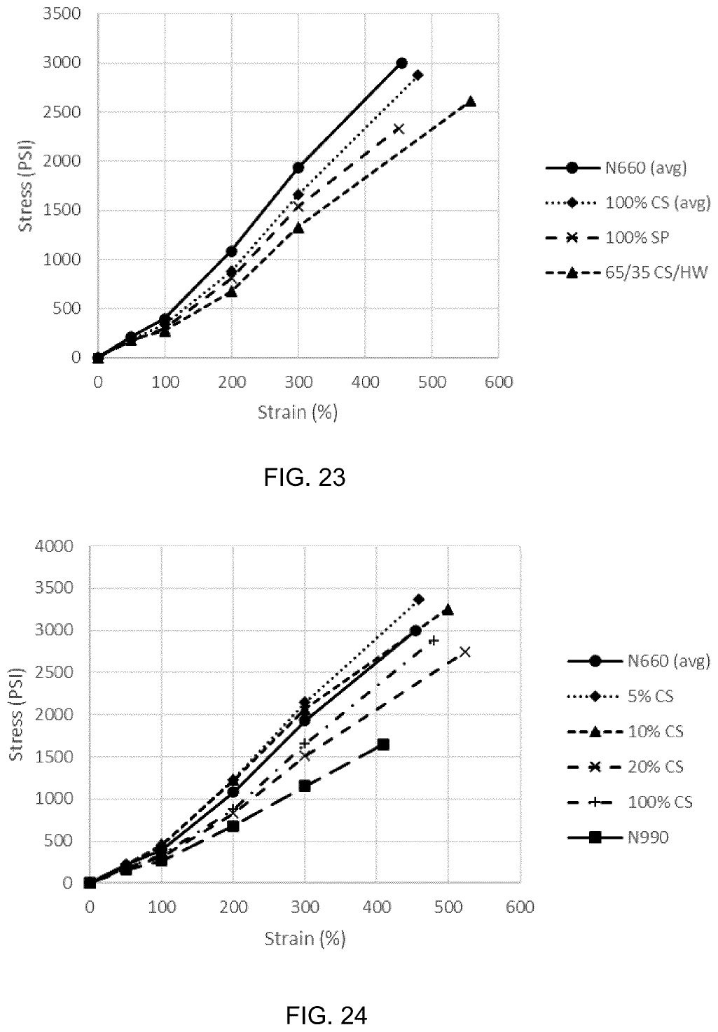

FIG. 23 and Table 6 show mechanical test results for media-milled carbonaceous material. Media milling can be more readily available, performed in smaller facilities and with less resources than jet milling. The samples in FIG. 23 and Table 6 were heat-treated at 1000° C. and milled using 3 mm media for 40 minutes in a planetary ball mill. The cure packages are different than the pure carbon black (CB) controls (i.e. N660, N990, etc.) and the blended material. The difference is that a higher amount of accelerator was used (1.9 phr TBBS), which was found to be required to avoid marching modulus when replacing 100% of the carbon black. One unexpected finding illustrated in FIG. 23 and Table 6 is that 100% cornstarch (CS)-derived carbonaceous material performs almost as well as N660 (and this is with two consistent replicates on different days). This is unexpected because, as described above, the primary particle size of CS-derived carbonaceous material has a D50 value of 200 nm or larger (e.g., 236 nm, compared to c. 45 nm for SP-derived carbonaceous material and approximately 49 to 60 nm for N660, and 200 to 500 nm for N990). Based on the particle size, one would expect poor reinforcing performance from CS-derived carbonaceous material, but in fact, the opposite is observed. This may be partially explained by the bound rubber (BR) and oil absorption (OAN) values, which for N990 are 3.64% BR and 40.3 g/100 g OAN, respectively, while CS-derived carbonaceous material has 50% BR and 65.4 g/100 g OAN. The much higher BR of CS-derived carbonaceous material indicates a high degree of polymer/filler interaction, while the higher OAN is indicative of higher structure (in this case, structure means how branched the aggregates particles are. For comparison, the OAN of N660 is 91.4 g/100 g, the OAN of 100% SP heat-treated carbonaceous material is in the range of 57 g/100 g to 75 g/100 g (with particular examples having a range of 71 g/100 g to 75 g/100 g), and the OAN of CS/HW parent carbonaceous material is 7.9 g/100 g. Additional results comparing performance with both N660 and N990 are shown in FIG. 24.

TABLE 6
Media-milling different feedstocks.

| | 100% | | | |
|---|---|---|---|---|
| | Southern | CS/HW | 100% CS | N660 |
| | pine | (65/35) | (avg) | (avg) |
| Tensile strength (PSI) | 2329 | 2612 | 2876 | 3000 |
| Elongation at break (%) | 450 | 558 | 479 | 455 |
| Bound rubber (%) | 51.42 | 49.46 | 49.96 | 41.87 |
| Shore A hardness | 63 | 58 | 62 | 65 |

Advantageously, the carbonaceous material disclosed herein also has low to non-detectable levels of polycyclic aromatic hydrocarbons (PAHs). Table 7 shows PAHs measured for a sample of N660, compared to that of parent and heat-treated carbonaceous material. This may be due to (i) the absence of PAHs in the feedstock used to create carbonaceous materials; and (ii) the high temperatures (T≥850° C.) used to create the carbonaceous materials (which cause desorption of such molecules from carbon surfaces).

TABLE 7
PAH measurements on N660, parent, and
heat-treated carbonaceous materials.

| | N660 | Parent | Heat-Treated |
|---|---|---|---|
| | mg/Kg | mg/Kg | mg/Kg |
| Acenaphthene | <0.2 | <0.2 | <0.2 |
| Acenaphthylene | <0.2 | <0.2 | <0.2 |
| Anthracene | 0.2 | <0.2 | <0.2 |
| Benzo(a)anthracene | <0.2 | <0.2 | <0.2 |
| Benzo(a)pyrene | <0.2 | <0.2 | <0.2 |
| Benzo(e)pyrene | <0.2 | <0.2 | <0.2 |
| Benzo(b)fluoranthene | <0.2 | <0.2 | <0.2 |
| Benzo(g, h, i)perylene | <0.2 | <0.2 | <0.2 |
| Benzo(k)fluoranthene | <0.2 | <0.2 | <0.2 |
| Benzo(j)fluoranthene | <0.2 | <0.2 | <0.2 |
| Chrysene | <0.2 | <0.2 | <0.2 |
| Dibenzo(a, h)anthracene | <0.2 | <0.2 | <0.2 |
| Fluoranthene | 6.8 | <0.2 | <0.2 |
| Fluorene | <0.2 | <0.2 | <0.2 |
| Indeno(1,2,3-cd)pyrene | <0.2 | <0.2 | <0.2 |
| Naphthalene | 0.3 | <0.2 | <0.2 |
| Phenanthrene | 2.35 | <0.2 | <0.2 |
| Pyrene | 26 | <0.2 | <0.2 |

In view of the many possible aspects to which the principles of the present disclosure may be applied, it should be recognized that the illustrated aspects are only preferred examples of the present disclosure and should not be taken as limiting the scope of the present disclosure. Rather, the scope of the disclosure is defined by the following claims. We therefore claim as our invention all that comes within the scope and spirit of these claims

We claim:

1. A carbonaceous material produced from a biomass feedstock, the carbonaceous material comprising:
a carbon content of greater than or equal to 85 wt. %;
a surface area ranging from 150 m²/g to 500 m²/g; and
an oil absorption value ranging from 50 g/100 g to 100 g/100 g.

2. The carbonaceous material of claim 1, wherein the biomass feedstock comprises a lignin-free material, a lignin-containing material, or a combination thereof.

3. The carbonaceous material of claim 1, wherein the biomass feedstock comprises cornstarch, a wood material, or a combination thereof.

4. The carbonaceous material of claim 1, wherein the biomass feedstock is cornstarch.

5. The carbonaceous material of claim 1, further comprising a portion of unreacted biomass feedstock, a macromolecular furan derivative, a cellulose compound, a lignin-based and/or lignin-derived compound, or a combination thereof.

6. The carbonaceous material of claim 5, wherein the macromolecular furan derivative is a humin.

7. The carbonaceous material of claim 1, wherein the oil absorption value ranges from 65 g/100 g to 80 g/100 g.

8. The carbonaceous material of claim 1, wherein the carbonaceous material is in the form of a particulate material comprising primary particles having (i) a D50 value of 200 nm or larger, or (ii) a D50 value of 30 nm to 100 nm.

9. The carbonaceous material of claim 1, wherein the carbonaceous material is obtained from heat-treating a parent carbonaceous material at a temperature of 800° C. to 1000° C.

10. The carbonaceous material of claim 1, wherein the carbonaceous material is obtained from heat-treating a parent carbonaceous material at a temperature of 850° C.

11. The carbonaceous material of claim 9, comprising less than 0.5 mg/kg of polycyclic aromatic hydrocarbons (PAHs).

12. The carbonaceous material of claim 9, comprising less than 0.2 mg/kg of polycyclic aromatic hydrocarbons (PAHs).

13. A composite polymer composition comprising:
a polymer matrix; and
a filler material dispersed within the polymer matrix, wherein at least a portion of the filler material comprises a first filler component that is the carbonaceous material of claim 1.

14. The composite polymer composition of claim 13, wherein the filler material further comprises a second filler component that is chemically distinct from the first filler component.

15. The composite polymer composition of claim 14, wherein the second filler component comprises carbon black obtained from a non-biomass-based feedstock.

16. The composite polymer composition of claim 13, wherein the first filler component is present in an amount ranging from greater than 0 to 60 wt. %.

17. The composite polymer composition of claim 13, having a tensile strength greater than or equal to 2500 psi.

18. The composite polymer composition of claim 13, wherein the polymer matrix comprises a thermoplastic polymer or an elastomer.

19. The composite polymer composition of claim 13, wherein the polymer matrix comprises one or more of styrene-butadiene rubber, butadiene rubber, ethylene propylene diene monomer rubber, isoprene rubber, butyl rubber, and natural rubber.

20. The composite polymer composition of claim 13, wherein the carbonaceous material of the first filler component is produced from cornstarch.

21. A rubber-containing product, comprising the composite polymer composition of claim 13.

22. The rubber-containing product of claim 21, wherein the rubber-containing product is a tire.

23. A composition, comprising:
a pre-polymer material; and
a filler material dispersed within the pre-polymer material, wherein at least a portion of the filler material comprises a first filler component that is the carbonaceous material of claim 1.

24. The composition of claim 23, wherein the pre-polymer material comprises styrene-butadiene rubber, butadiene rubber, ethylene propylene diene monomer rubber, isoprene rubber, butyl rubber, and natural rubber.

25. A method of producing a carbonaceous material, the method comprising:
obtaining a parent carbonaceous material from a biomass feedstock, the parent carbonaceous material comprising a portion of unreacted biomass feedstock, a macromolecular furan derivative, a cellulose compound, a lignin-based and/or lignin-derived compound, or a combination thereof; and
post-treating the parent carbonaceous material to at least partially deoxygenate the parent carbonaceous material to provide the carbonaceous material, wherein post-treating the parent carbonaceous material does not comprise treating the parent carbonaceous material with an activating agent,
wherein the carbonaceous material comprises: a carbon content of greater than or equal to 85 wt. %; a surface area ranging from 150 m²/g to 500 m²/g; and an oil absorption value ranging from 50 g/100 g to 100 g/100 g.

26. The method of claim 25, wherein post-treating the parent carbonaceous material comprises heat-treating the carbonaceous material.

27. The method of claim 25, wherein heat-treating the parent carbonaceous material comprises heating the parent carbonaceous material at a temperature ranging from 300° C. to 1000° C.

28. The method of claim 25, wherein post-treating the parent carbonaceous material comprises converting at least a portion of the parent carbonaceous material to turbostratic carbon.

29. The method of claim 25, wherein the carbonaceous material is a particulate material and the method further comprises reducing an aggregate particle size of the carbonaceous material.

30. The method of claim 29, wherein reducing the aggregate particle size of the carbonaceous material comprises milling the carbonaceous material.

31. The method of claim 30, wherein milling comprises jet milling, ball milling, media milling, or a combination thereof.

32. The method of claim 25, further comprising:
combining the carbonaceous material with a pre-polymer material; and
curing and/or hardening the pre-polymer material in the presence of the carbonaceous material to form a composite polymer composition.

33. The method of claim 32, wherein forming the composite polymer composition comprises forming a rubber-containing product.
